(19) United States
(12) Patent Application Publication
(10) Pub. No.: US 2026/0145070 A1
(43) Pub. Date: May 28, 2026

(54) MULTIPLAYER ONLINE MICRO-EVENT PREDICTION GAME

(71) Applicants: Michael Patrick Foss, Farmington, CT (US); Matthew Christian Foss, Farmington, CT (US)

(72) Inventors: Michael Patrick Foss, Farmington, CT (US); Matthew Christian Foss, Farmington, CT (US)

(21) Appl. No.: 19/401,064

(22) Filed: Nov. 25, 2025

Related U.S. Application Data
(60) Provisional application No. 63/725,627, filed on Nov. 27, 2024.

(51) Int. Cl. A63F 13/533; A63F 13/355; A63F 13/44; A63F 13/798

(52) U.S. Cl. CPC A63F 13/533; A63F 13/355; A63F 13/44; A63F 13/798

(57) ABSTRACT

Systems and methods for multiple players to predict outcomes of live micro-events in a macro-event and for comparing predictions to actual outcomes of the live micro-events and calculating point scores for the predictions.

### CROSS REFERENCE TO RELATED APPLICATION

This application claims the benefit and priority of U.S. Provisional Ser. No. 63/725,627, filed on Nov. 27, 2024, entitled “Multiplayer Online Micro-Event Prediction Game,” the entirety of which is incorporated herein by reference.

### FIELD OF THE TECHNOLOGY

The present invention is directed to a multiplayer online micro-event prediction game and in particular to a mass multiplayer online game for predicting, comparing predictions on a real-time basis to live micro-events (e.g., plays) in a live macro-event (e.g., sporting events) and scoring outcomes of the predictions all on a real-time basis, for example, while watching the live event real-time, on a play-by-play basis.

### BACKGROUND

There are many on-line betting platforms that allow users to bet on outcomes of live macro-events such as sporting events. However, there are significant technical challenges in being able to quickly download outcomes of live micro-events in such macro-events. One example of the technical challenges is the difficulty in communicating with a network broadcast of the live macro-event, downloading the outcomes of the live micro-events and communicating them to a computer processor for scoring and display. In addition, some betting platforms are standalone from the live macro-event which makes it difficult to coordinate viewing of the micro-events with predicting outcomes of the live micro-events. Furthermore, the downloading and processing of the outcomes of live micro-events is a practical application and that cannot be reasonable performed by the human mental process, due to the rapid speed required to perform such steps for multiple users (e.g., 1,000 or more users). Moreover, generic computers are not capable of performing these mental processes because of the multiple interfaces required, including interfacing with the network broadcast of the live micro-events, interpreting the outcomes and processing them for scoring via another processor. As a result of these technical challenges, determination, and evaluation of the outcomes of live micro-events has not been able to be efficiently achieved on a real-time basis.

Based on the foregoing, there is a need for an improved system and software for downloading, evaluating, scoring, and displaying outcomes on a real-time basis, that could not be performed by the human mind alone.

### SUMMARY

There is disclosed herein a system for multiple players to predict outcomes of live micro-events in a macro-event and for comparing predictions to actual outcomes of the live micro-events. The system includes, (a) a video source that is configured to record and transmit live video signals of the micro-events; and (b) a cloud based platform, The cloud based platform includes a first non-transitory computer readable storage medium that includes first computer-executable instructions. The cloud based platform also includes a second non-transitory computer readable storage medium that includes at least one backend server and second computer-executable instructions. The cloud based platform also includes a video signal processor that is in communication with the video source and includes at least one video encoding and distribution module. The system also includes a management application that includes a broadcast studio, game management (e.g., one or more human game managers or human operators), a user management, and a platform configuration. The management application is in communication with: (i) the at least one backend server for sharing real-time and pre-programed information back and forth between the management application and the at least one backend server; and (ii) the video signal processor for transmitting the live video signals back and forth between the video signal processor and the management application. The system also includes a plurality of user communication devices each being in communication with the at least one video encoding and distribution module. Each of the plurality of user communication devices have a graphical user interface that includes an event viewing section and a prediction input and outcome display section. The prediction input and outcome display section is configured to receive user predictions of a plurality of the micro-events before the micro-event starts and for displaying the outcomes of the plurality of micro-events before the start of a subsequent live micro-event. Each of the plurality of user communication devices have a video player that is in communication with the event viewing section. Each of the plurality of user communication devices have a game controller that is in communication with the prediction input and outcome display section. Each of the plurality of user communication devices have a user results module that is in communication with the prediction input and outcome display section. The user results module is configured to calculate and display user scores based on a comparison of the user predictions to the outcomes of the plurality of micro-events. Each of the plurality of user communication devices have a data and predictions module in communication with the prediction input and outcome display section.

In some embodiments, the system includes primary display that is in communication with the at least one video encoding and distribution module for receiving the live video signals and displaying the live macro-event.

In some embodiments, the system includes a plurality of data feeds that are in communication with the first non-transitory computer readable storage medium for transmitting supplementary real-time information to the first non-transitory computer readable storage medium.

In some embodiments, the first algorithm generates input time-stamp limits to a count-down clock in the prediction input module, the input time-stamp limits automatically close a window of time for entry of the user predictions.

In some embodiments, the prediction input and outcome display section is configured to receive and process the users predictions for at least one of winner of a segment of a macro-event and a winner of the entire macro-event.

In some embodiments, the macro-event is a football game and the prediction input and outcome display section is configured to receive and process the users predictions for at least one over/under scores for a game quarter, field position after kick-off, type of play, touchdown, turnover, incomplete pass, no gain, punt, field goal attempt result, and points achieved after a touchdown.

In some embodiments, the graphical user interface includes a listing of a plurality of users'points resulting from the user predictions.

There is also disclosed herein a system for multiple players predicting outcomes of live micro-events in a macro-event and for comparing predictions to actual outcomes of the live micro-events. The system includes a gaming environment that is accessible by a plurality of user communication devices located remotely from the live macro-event. Each of the user communication devices has a graphical user interface that includes an event viewing section and a prediction input and outcome display section. The system includes a first computer processor that has a first non-transitory computer readable storage medium that includes first computer-executable instructions and has a first algorithm in communication with a broadcast network of the event. The first algorithm is configured to download real-time video and audio signals of the live micro-events and convert the real-time video and audio signals into time-stamped signals for real-time display on the event viewing section of the graphical user interface. The system includes a second computer processor that has software which includes a second non-transitory computer readable storage medium that has second computer-executable instructions and has a second algorithm that has a prediction input module configured to document user predictions of the micro-event entered by the users via the user communication devices. The system includes a master platform module and an outcome module. The second algorithm is in communication with the first algorithm for downloading real-time outcomes of the micro-event. The master platform is configured to calculate scoring of the user predictions of the live micro-events based upon the real-time outcomes of the live micro-events and display the outcomes and scoring on the prediction input and outcome display section of the graphical user interface, before the start of a subsequent live micro-event.

In some embodiments, the first algorithm generates input time-stamp limits to a count-down clock in the prediction input module, the input time-stamp limits automatically close a window of time for entry of the user predictions.

There is also disclosed herein a method for facilitating real-time comparison of outcome predictions for live micro-events within a live macro-event. The method includes digitalizing a live macro-event into a plurality of discrete digital components. Each of the discrete digital components includes a time component which corresponds to at least one information component. The method includes defining a plurality micro-events. Each micro-event of the plurality of micro-events includes a micro-event time cap which corresponds to a prediction score. The method includes receiving a first micro-event prediction and a second micro-event prediction; and comparing the first micro-event prediction to the live micro-event outcome.

There is further disclosed herein a method for facilitating real-time comparison of outcome predictions for live micro-events within a live macro-event. The method includes digitalizing video of the live micro-event into a plurality of first discrete digital components. The method also includes transmitting the plurality of first discrete digital components to a game engine which has a first non-transitory computer readable storage medium comprising first computer-executable instructions. The method includes digitalizing user predictions of the outcome of a live macro-event and the data feeds 2800 into a plurality of second discrete digital components. The method also includes transmitting the plurality of second discrete digital components to a backend server via at least one user communication device. The backend server has a second non-transitory computer readable storage medium that includes second computer-executable instructions. The method also includes transmitting the second discrete digital components to the game engine and comparing, via the game engine, the second discrete digital components to the actual outcome of the live micro-event. The method also includes calculating user points from the comparison and points criteria stored in the first computer-executable instructions. The method also includes transmitting the user points to the backend server via the game engine; and transmitting the user points to the user communication devices via the backend server. The game engine is part of the software and algorithms in the backend server, which is part of the cloud platform.

There is further disclosed herein, a method of updating icons on a graphical user interface of a computer system. The method includes displaying on a prediction input and outcome display section of the graphical user interface a plurality of input selection icons. The method also includes automatically generating input time-stamp limits via a processor that tracks historical user time to enter predictions, the input time-stamp limits automatically close a window of time for entry of the user predictions into the plurality of input selection icons. The method includes calculating user scores and results based on the processor analysis of a micro event (e.g., plays in a sporting event) automatically hiding the plurality of input selection icons based on the processor determining the status of the micro event. The method includes displaying a plurality for results icons via the processor on the graphical user interface and updating via the processor the plurality of input selection icons before a next micro event starts. In some embodiments, the method includes the processor further updating the graphical user interface with a leader score icon. In some embodiments, the method includes the processor further updating the graphical user interface with a statistics icon.

### BRIEF DESCRIPTION OF THE DRAWINGS

FIG. 1 is a flow chart of a system for multiple players predicting outcomes of live micro-events in a macro-event and for comparing predictions to actual outcomes of the live micro-events of the present invention;

FIG. 2 is a flow chart of the sequence of data exchange and processing of the system of FIG. 1;

FIG. 3 is a schematic drawing of a screen of a graphical user interface of the system of FIG. 1;

FIG. 4 is a schematic drawing of a screen of a graphical user interface of the system of FIG. 1;

FIG. 5 is a schematic drawing of a screen of a graphical user interface of the system of FIG. 1;

FIG. 6 is a schematic drawing of a screen of a graphical user interface of the system of FIG. 1;

FIG. 7 is a schematic drawing of a screen of a graphical user interface of the system of FIG. 1;

FIG. 8 is a flow chart showing sequential screens of a graphical user interface of the system of FIG. 1;

FIG. 9 is a flow chart showing sequential screens of a graphical user interface of the system of FIG. 1;

FIG. 10 is a schematic view of a master control layout;

FIG. 11 is a schematic view of a master control layout;

FIG. 12 is a schematic view of a master control layout showing scores and graphical user interfaces for two players;

FIG. 13 is a flow chart of sequential screens of a graphical user interface of the system of FIG. 1 and illustrating indicia for stages of user prediction expiration time;

FIG. 14 is a schematic diagram of another embodiment of a system for multiple players predicting outcomes of live micro-events in a macro-event and for comparing predictions to actual outcomes of the live micro-events of the present invention;

FIGS. 15-94 are examples of various graphical user interfaces of the system of FIG. 1.

### DETAILED DESCRIPTION

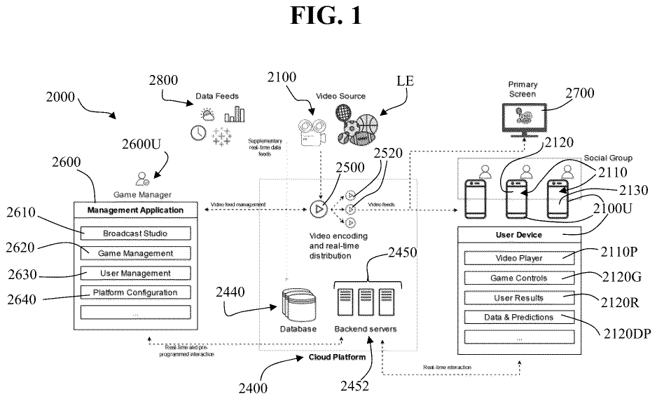

As shown in FIG. 1, a system for multiple players to predict outcomes of live micro-events in a macro-event LE and for comparing predictions to actual outcomes of the live micro-events, is generally designated by the numeral 2000. The macro-events include sports events such as football, baseball, soccer, basketball, volleyball, and golf. Micro-events include, but are not limited to, individual plays in a football game, quarters in a football game, at-bats in a baseball game and innings in a baseball game.

As shown in FIG. 1, the system 2000 includes: a video source 2100 (and in some embodiments an audio source) configured to record and transmit live video signals (an in some cases audio signals) of the micro-events; and a cloud based platform 2400 (i.e., a system that allows users to access computing resources over the internet, including: databases that store and retrieve data, analytics for analyzing data, storage for data back-up, networking and downloadable software). The cloud based platform 2400 includes a first non-transitory computer readable storage medium 2440 comprising first computer-executable instructions; a second non-transitory computer readable storage medium 2450 comprising at least one backend server 2452 and second computer-executable instructions; and a video signal processor 2500 in communication with the video source 2100 and comprising at least one video encoding and distribution module 2520. The backend servers run the software for the system 2000. This includes authentication and authorization for users (verifying who they are and what permissions they have); storing data in the database or other storage mediums; interacting with any third-party services; providing Application Programming Interface for the management application and user device interaction with the cloud platform 2400.

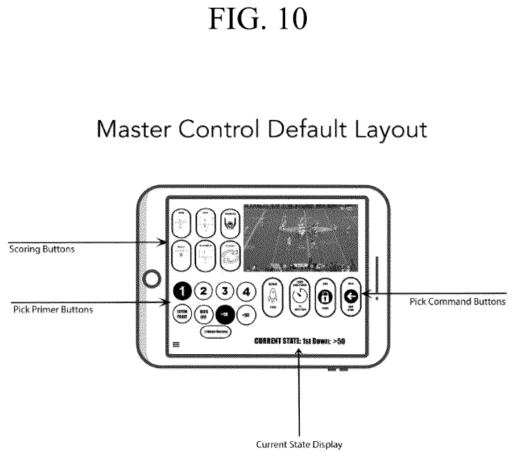

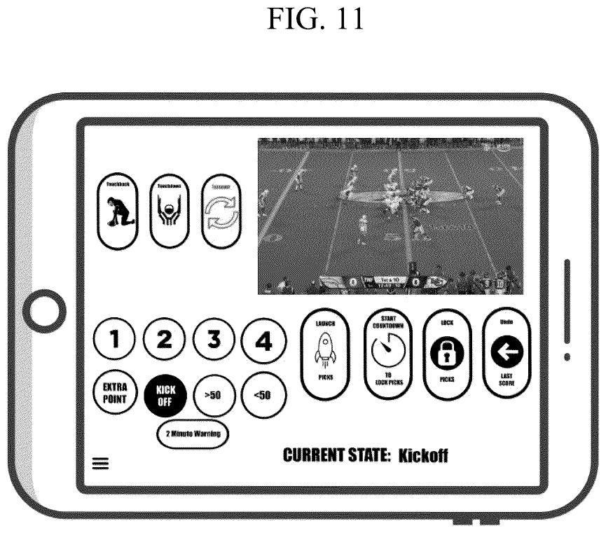

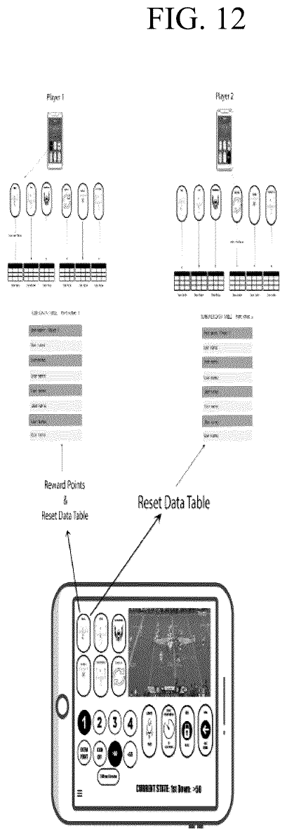

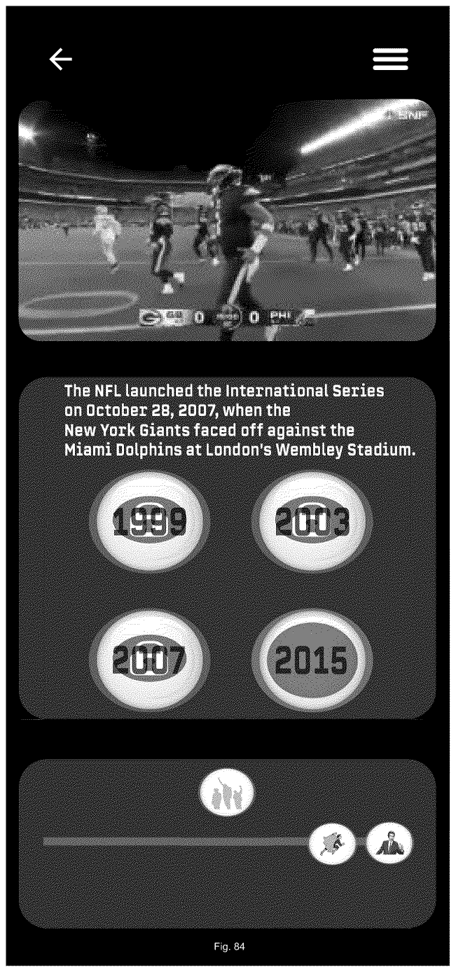

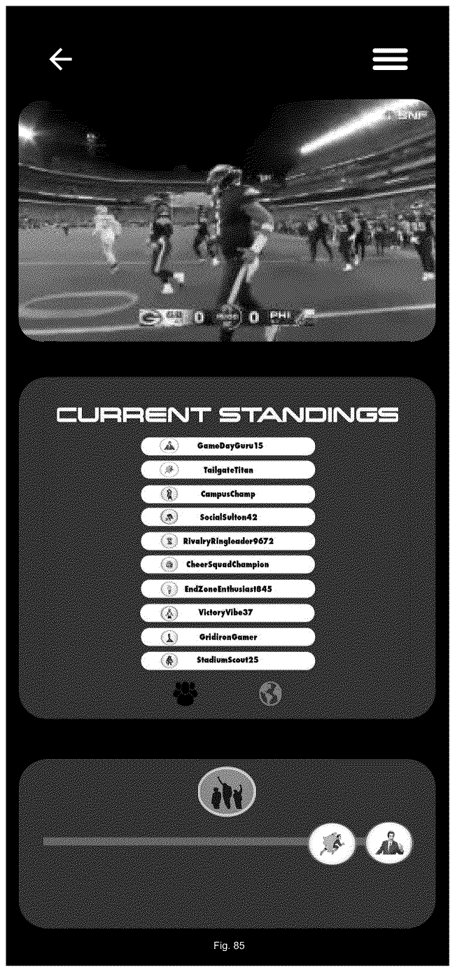

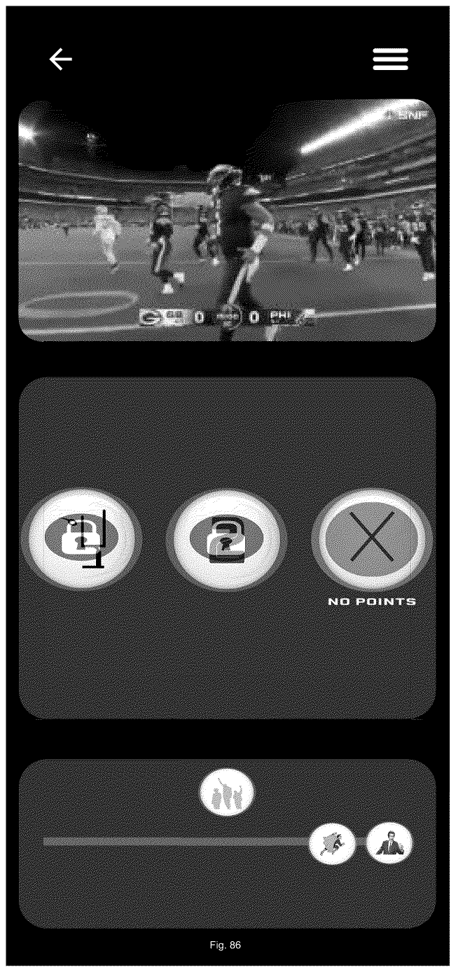

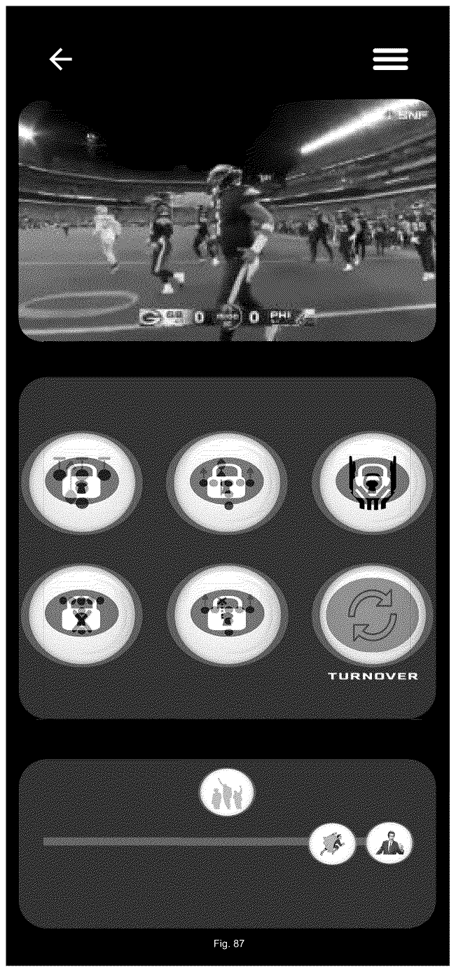

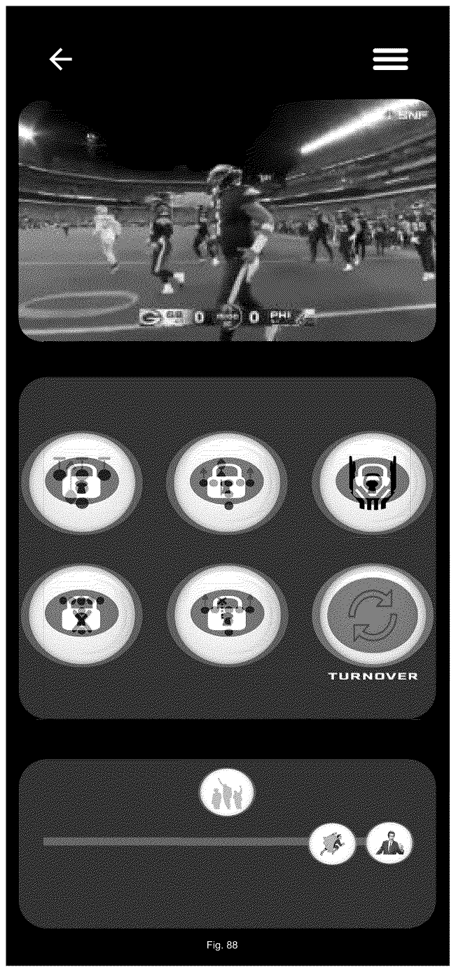

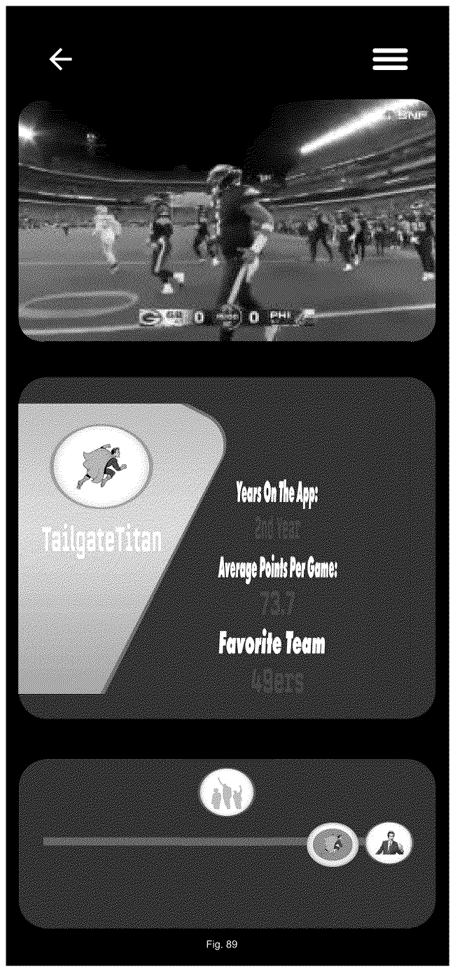

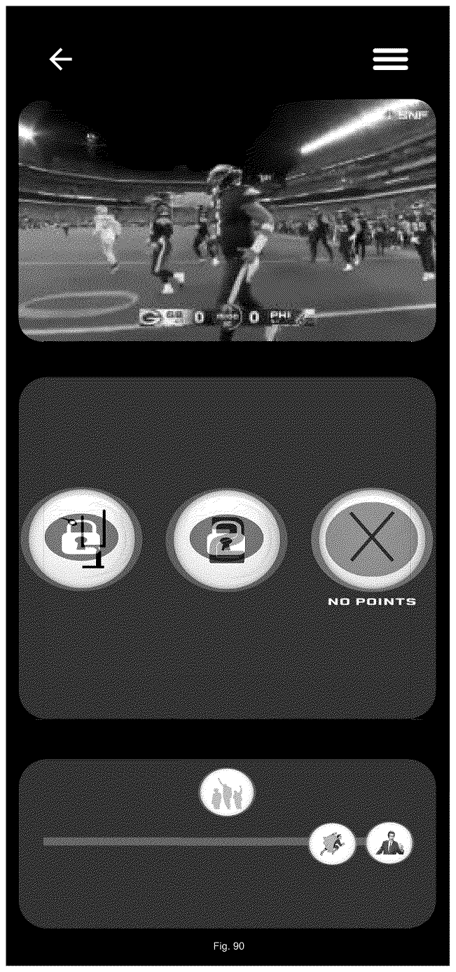

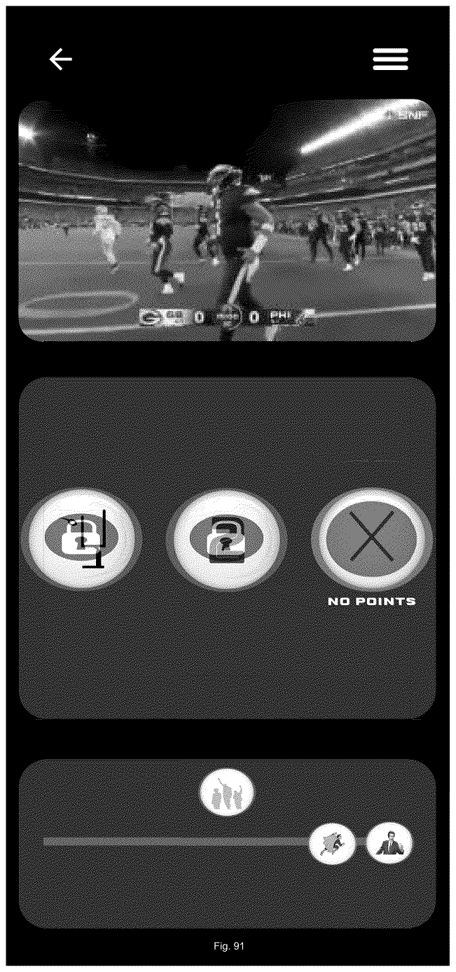

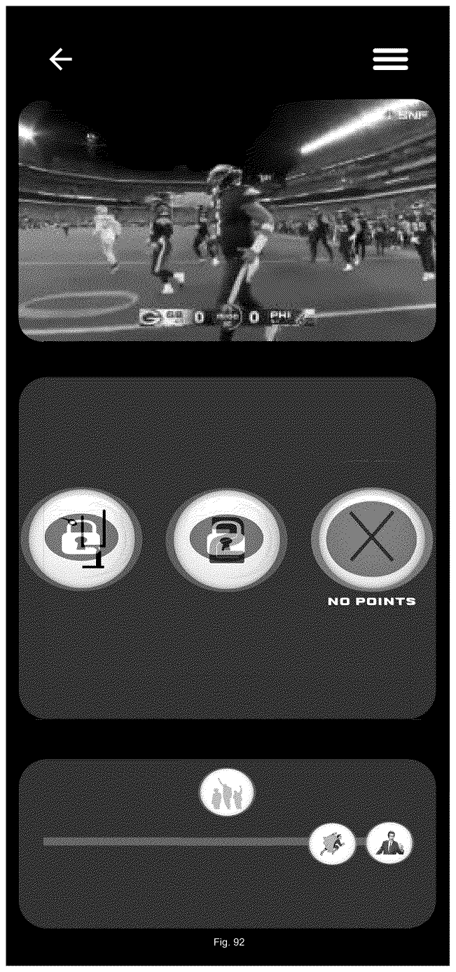

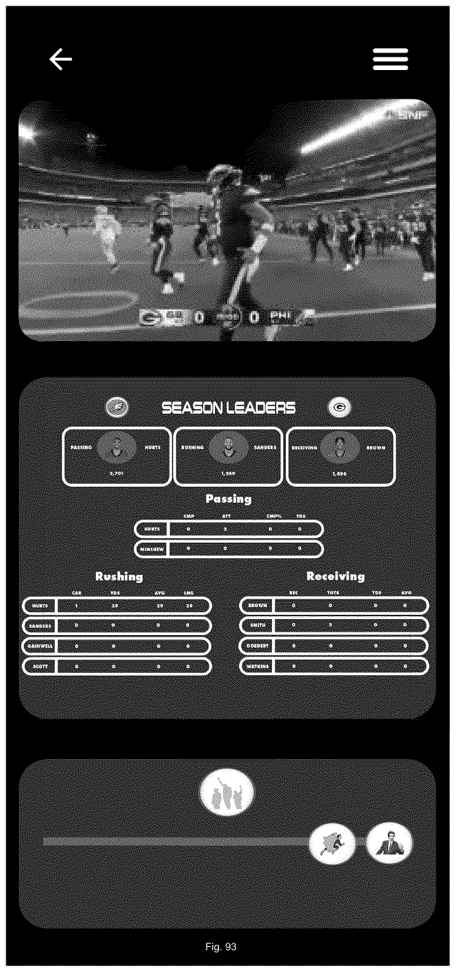

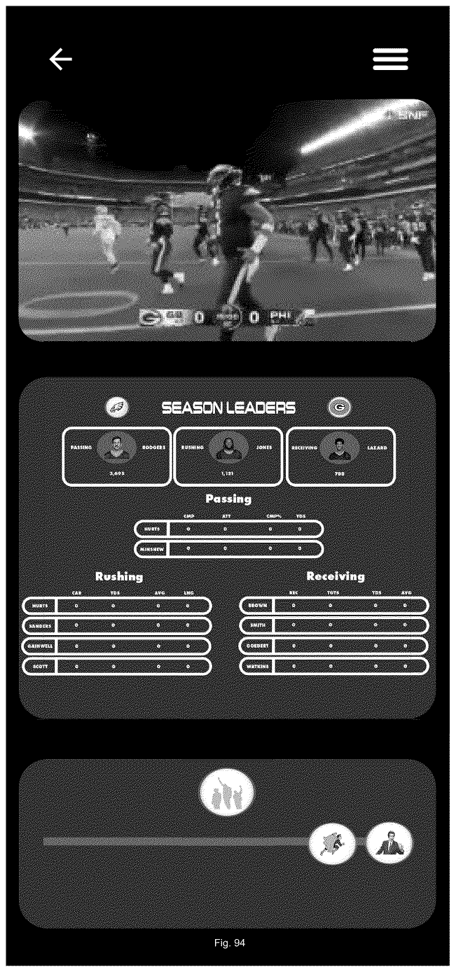

As shown in FIG. 1, the system 2000 includes: a management application 2600. The management application 2600 (also referred to as the master control interface) in some embodiments, requires human actions, where the operator is a human game manager 2620 (also referred to as game management) alongside the macro-event broadcaster 2610 (also referred to as broadcast studio). The responsibility of the game manager 2620 and the macro-event broadcaster is to control the flow of the micro-events for the rest of the users-e.g., creating time-stamps indicating when inputs are frozen for the current play time-stamp; what the outcome of the current play is/was; if there's a break in the match for whatever reason; and set up game/match information such as teams, and players. This consists of a “game control” user interface, as shown in FIGS. 10-12, which then communicates with the cloud platform 2400 and backend servers 2452, which in turn broadcasts out to the end user devices 2100U as required freezing inputs, and showing scores and points earned. The management application 2600 includes a broadcast studio 2610, a game management 2620, a user management 2630, and a platform configuration 2640. The user management 2630 provides authentication and authorization of users; and controls and delegates permissions to users to allow them to create their own leagues and groups for local competitions. Additional examples, of graphical user interfaces of the system 2000 are provided in FIGS. 15-94.

As shown in FIG. 1, the platform configuration provides general settings around whether or not live events are enabled for the whole platform, video broadcast configuration, branding and styling, sponsorship logos, and sending out notifications to all users. The management application 2600 is in communication with: (i) the at least one backend server 2452 for sharing real-time and pre-programed information back and forth between the management application 2600 and the at least one backend server 2452; and (ii) the video signal processor 2500 for transmitting the live video signals back and forth between the video signal processor 2500 and the management application 2600.

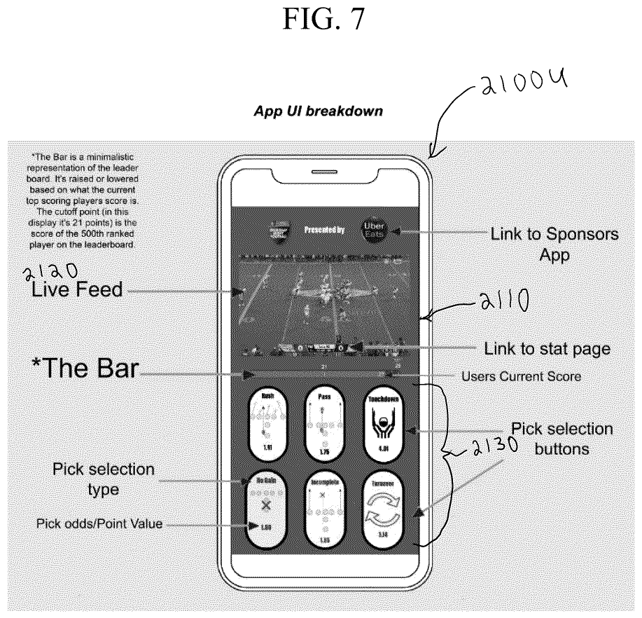

As shown in FIGS. 1 and 7, the system 2000 includes: a plurality of user communication devices 2100U (e.g., cell phones, laptop computers, i-pads, etc.) each of which are in communication with the at least one video encoding and distribution module 2520. Each of the plurality of user communication devices 2100U has: (I) a graphical user interface 2110 that includes an event viewing section 2120 and a prediction input and outcome display section 2130 that are selectable based upon the stage of user participation in the prediction and scoring process. The prediction input and outcome display section 2130 is configured to receive user predictions of a plurality of the micro-events before the micro-event starts and for displaying the outcomes of the plurality of micro-events before the start of a subsequent live micro-event; (II) a video player 2110P in communication with the event viewing section 2120; (III) a game controller 2120G in communication with the prediction input and outcome display section 2130; (IV) a user results module 2120R in communication with the prediction input and outcome display section 2130, the user results module being configured to calculate and display user scores based on a comparison of the user predictions to the outcomes of the plurality of micro-events; and (V) a data and predictions module in communication with the prediction input and outcome display section 2130. The video player 2110P provides a live feed of the macro event. The game controller 2120G transmits user inputs to the outcome display section 2130. The data predictions module 2120DP—interacts with the prediction input and outcome display section 2130 (see also FIG. 7) to input the pick odds/point values that update during the macro event or potentially even during the micro event play, in which case the data and predictions module 2120DP is responsible for updating these value, for example, if a play is close to the goal line then the data and predictions might give this a lower points scoring value than if it was at the 40 yard line. The user results module 2120R covers the scoring and results display functionality, such as shown in FIG, 6 for example.

As shown in FIG. 1, in some embodiments the system 2000 includes a primary display 2700 in communication with the at least one video encoding and distribution module 2520 for receiving the live video signals and displaying the live macro-event LE.

As shown in FIG. 1, in some embodiments the system includes a plurality of data feeds 2800 in communication with the first non-transitory computer readable storage medium 2440 for transmitting supplementary real-time information to the first non-transitory computer readable storage medium 2440. The plurality of data feeds 2800 include, but are not limited to, weather information, time, statistics, and trivia.

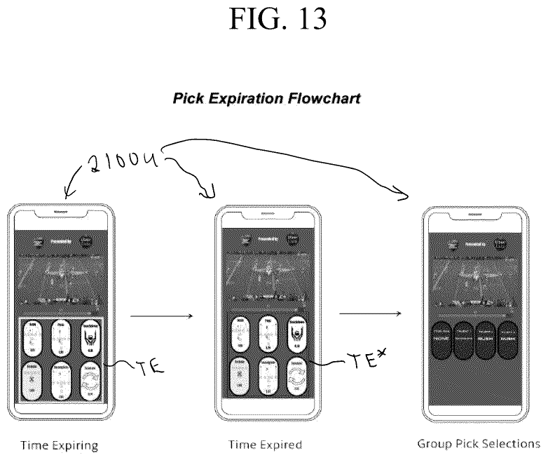

In some embodiments, the first algorithm generates input time-stamp limits to a count-down clock in the prediction input module. The input time-stamp limits automatically close (i.e., freeze) a window of time for entry of the user predictions. For example, FIG. 13 employs a yellow border located around the user's prediction (i.e., pick) to indicate that the input time-stamp limit is approaching and employs a red border located around the user's prediction (i.e., pick) to indicate that the input time-stamp limit has expired, thereby preventing the user to enter a prediction for the current micro event. FIG. 13 also shows a summary of prediction (i.e., pick) selections for four users in a group. In some embodiments, a computer processor is configured to execute the first algorithm which is a machine learning algorithm that is fed data inputs (e.g., historical or game manager generated inputs) to predict and output the time-stamp limits for other micro-events.

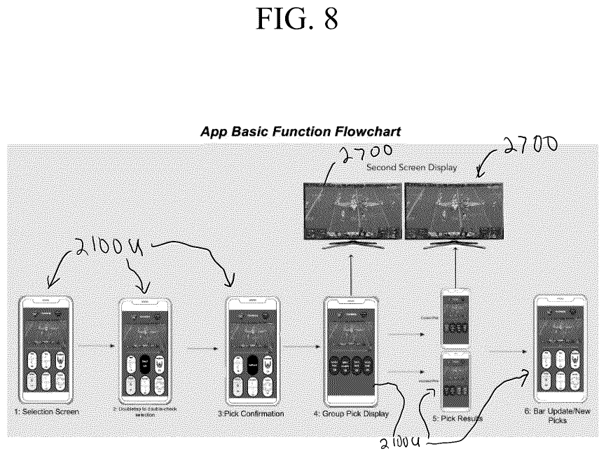

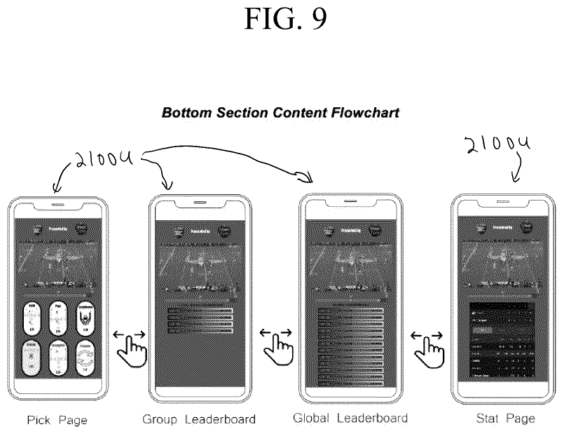

As shown in FIGS. 8 and 9, there is disclosed a method of updating icons on a graphical user interface (2100) of a computer system (2450) which provides a specific improvement over prior systems, resulting in an improved graphical user interface for electronic devices. The method includes displaying on a prediction input and outcome display section (2130) of the graphical user interface (2100) a plurality of input selection icons. The method also includes automatically generating input time-stamp limits via a processor (e.g., the backend server, 2452) that tracks historical user time to enter predictions based on an analysis of data time entry in the memory of the processor 2452, the input time-stamp limits automatically close a window of time for entry of the user predictions into the plurality of input selection icons. Such time stamp limits cannot be practically performed in the human mind. The method includes calculating user scores and results based on the processor (2452) analysis of a micro event (e.g., plays in a sporting event) automatically hiding the plurality of input selection icons based on the processor determining the status of the micro event. The method includes displaying a plurality for results icons via the processor on the graphical user interface (2100) and updating via the processor (2452) the plurality of input selection icons before a next micro event starts. In some embodiments, the method includes the processor (2452) further updating the graphical user interface with a leader score icon. In some embodiments, the method includes the processor (2452) further updating the graphical user interface with a statistics icon.

FIGS. 10-12 illustrate stages and display layout of a master control module in the form of detailed graphical user interface details, which allows the game management 2620 to make real-time, micro event and situational based decisions. FIGS. 10-12 demonstrate the fundamental logic and decision making priorities of the game management 2620, shown in FIG. 1.

In some embodiments, the prediction input and outcome display section 2130 is configured to receive and process the users predictions for at least one of winner of a segment of a macro-event and a winner of the entire macro-event. In some embodiments, the system 2000 includes artificial intelligence functionality designed to allow users to reference historically-based, statistical percentages of likely outcomes for all possible down/distance combinations. These percentages will be visible to individual players as a secondary display option within the prediction input and outcome display section 2130 (e.g., Select Play” icons).

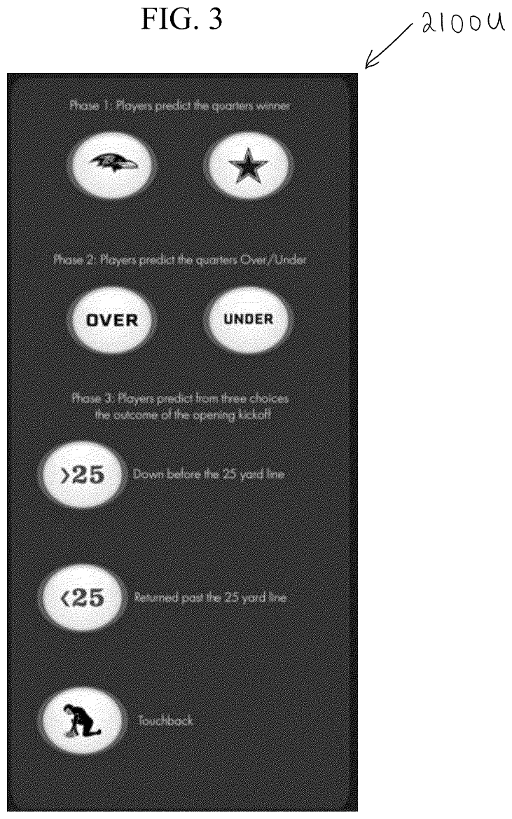

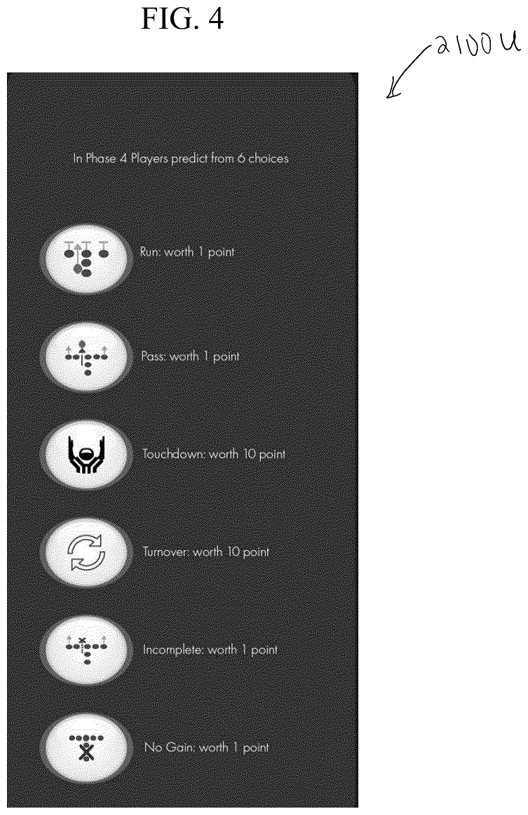

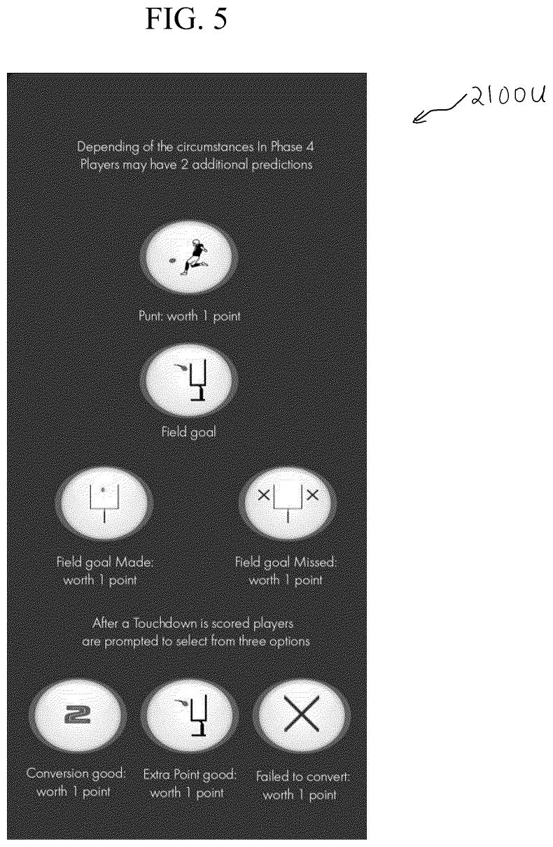

In some embodiments, the macro-event is a football game and the prediction input and outcome display section 2130 is configured to receive and process the users predictions for at least one over/under scores for a game quarter, field position after kick-off, type of play, touchdown, turnover, incomplete pass, no gain, punt, field goal attempt result, and points achieved after a touchdown, as shown in FIGS. 3-5.

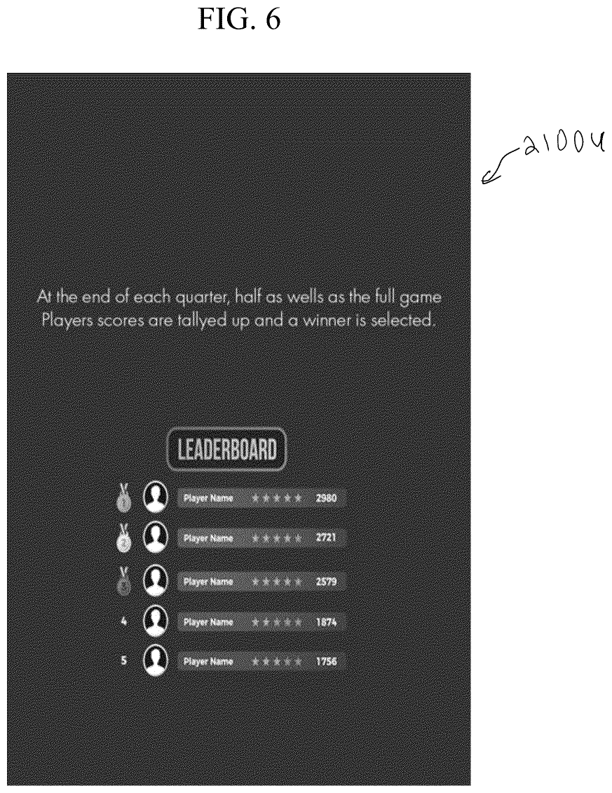

In some embodiments, the graphical user interface 2110 includes a listing of a plurality of users'points resulting from the user predictions, as shown in FIGS. 6 and 9.

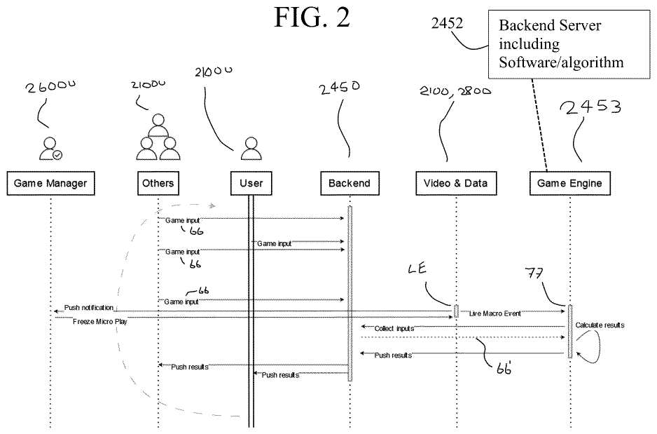

As shown in FIG. 2, there is disclosed herein a method for facilitating real-time comparison of outcome predictions for live micro-events within a live macro-event. The method includes digitalizing video 2100 of the live micro-event and the data feeds 2800 into a plurality of first discrete digital components 77 and transmitting plurality of first discrete digital components 77 to a game engine 2453 that includes a first non-transitory computer readable storage medium that includes first computer-executable instructions. The game engine 2453 is part of the software and algorithms in the backend server 2452, which is part of the cloud platform 2400. The method includes digitalizing user predictions of the outcome of a live macro-event LE into a plurality of second discrete digital components 66 (e.g., game inputs) and transmitting the plurality of second discrete digital components 66 to a backend server 2452 having a second non-transitory computer readable storage medium 2450 comprising second computer-executable instructions. The method includes transmitting the second discrete digital components 66′ to the game engine 2453. The game engine 2453 compares the second discrete digital components 66′ (i.e., user predictions) to the actual outcome of the live micro-event to calculate user points (i.e., results). The user points are transmitted to the backend server 2452 which transmits the user points to the user communication devices 2100U. In some embodiments, the game manager 2600U controls the input of user predictions by freezing the time for input of the user predictions. In addition, the game manager 2600U receives push notifications of each micro event of the live macro event LE from the video 2100 and data feeds 2800. The game engine is the software/algorithmic part of the cloud platform 2400, running on the backend servers 2452, that captures the live macro event game mechanics (i.e. the rules of the sport that are being watched), as well as the play by play multiplayer micro event game mechanics, and takes the user prediction inputs and the video 2100 and data feeds 2800 to determine the outcomes, results and scores.

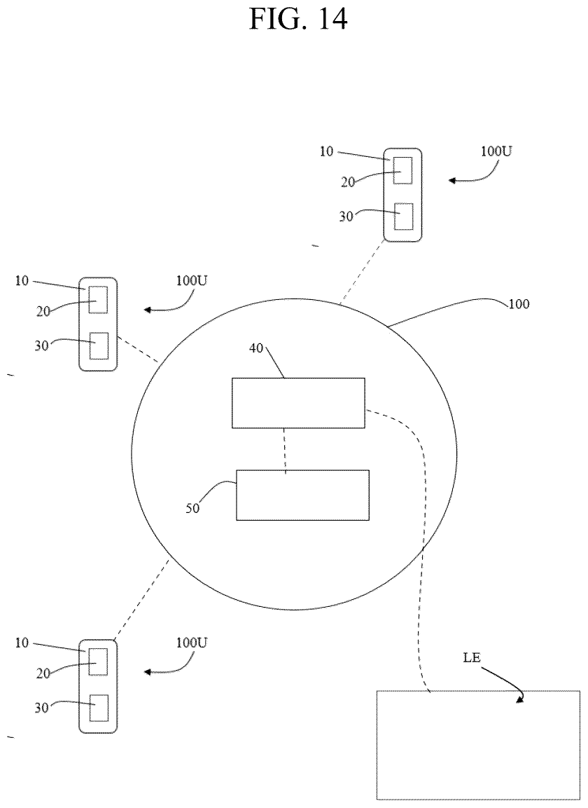

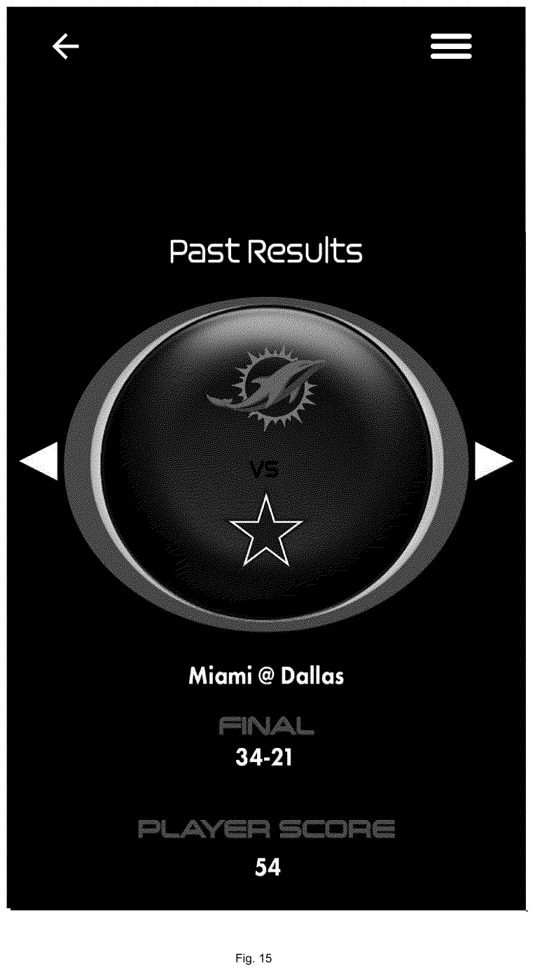

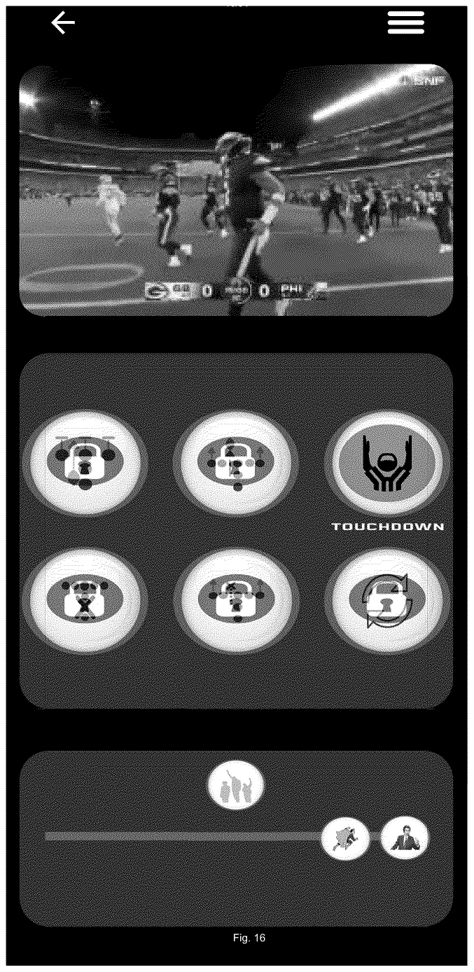

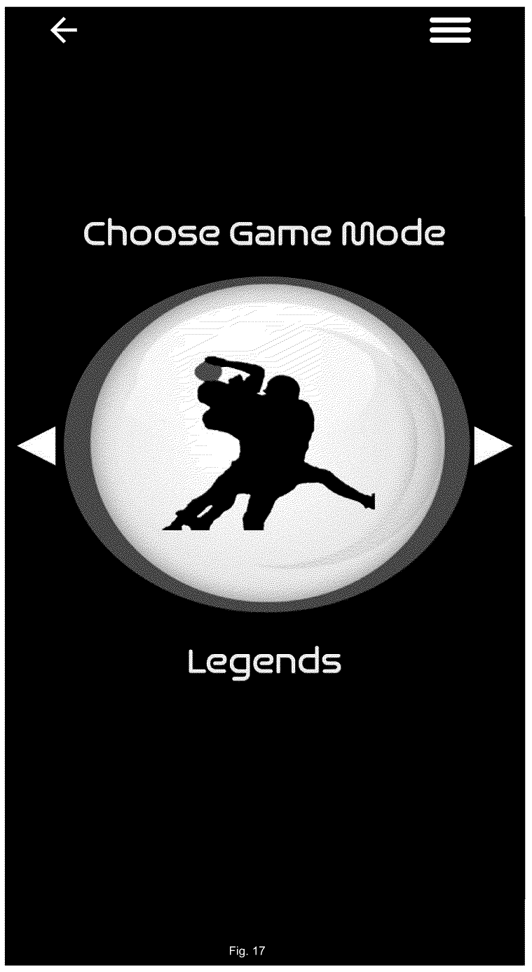

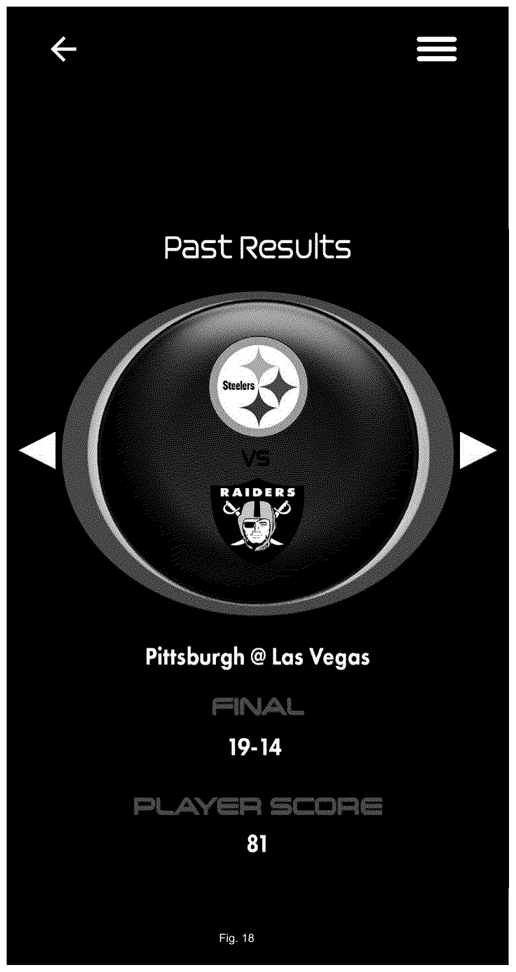

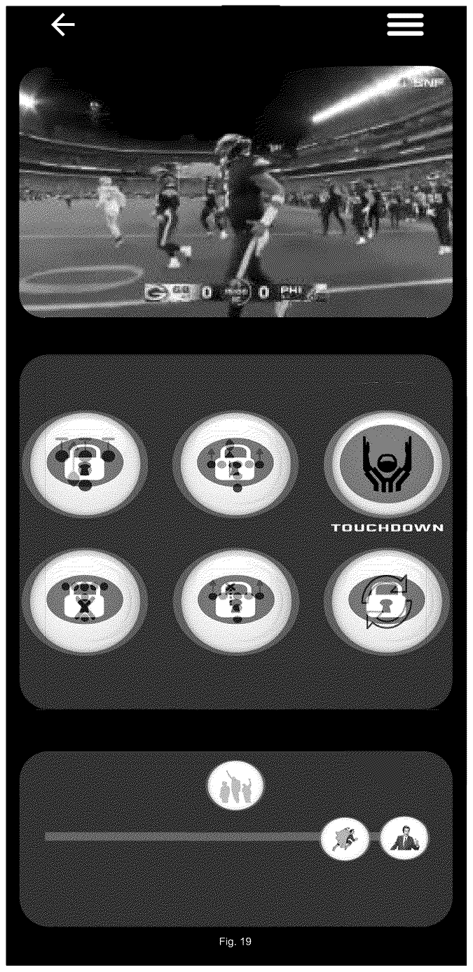

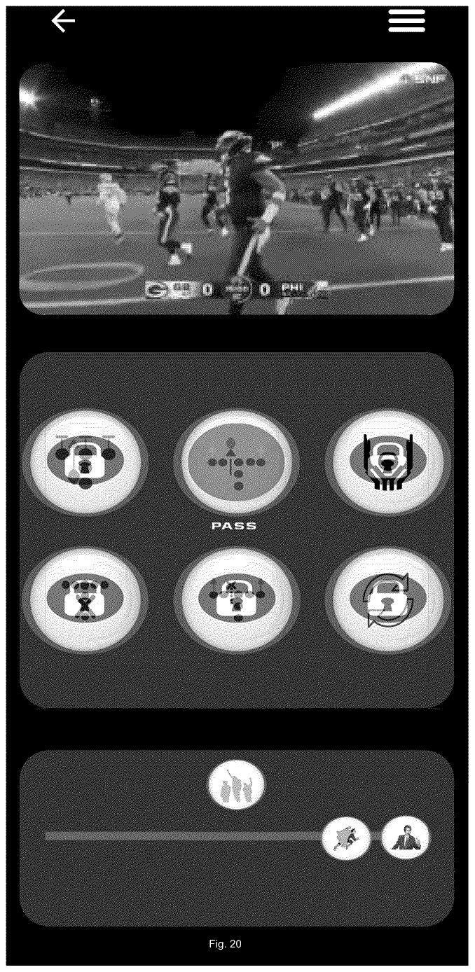

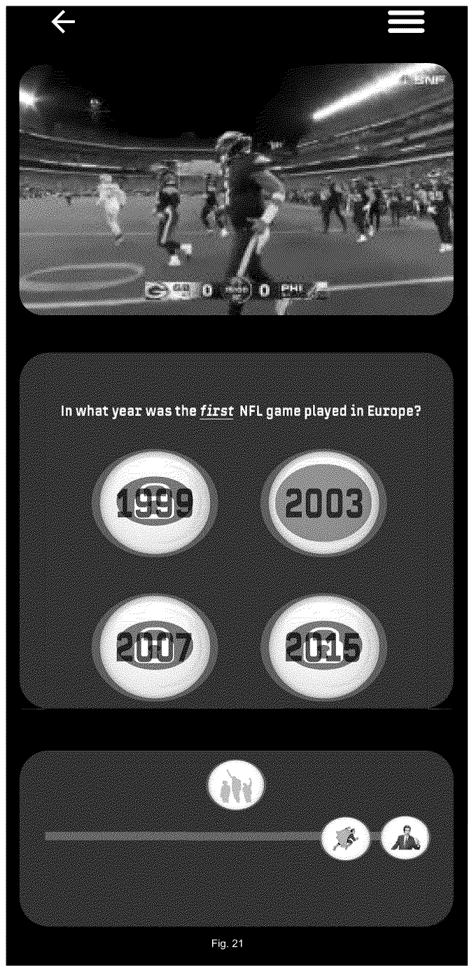

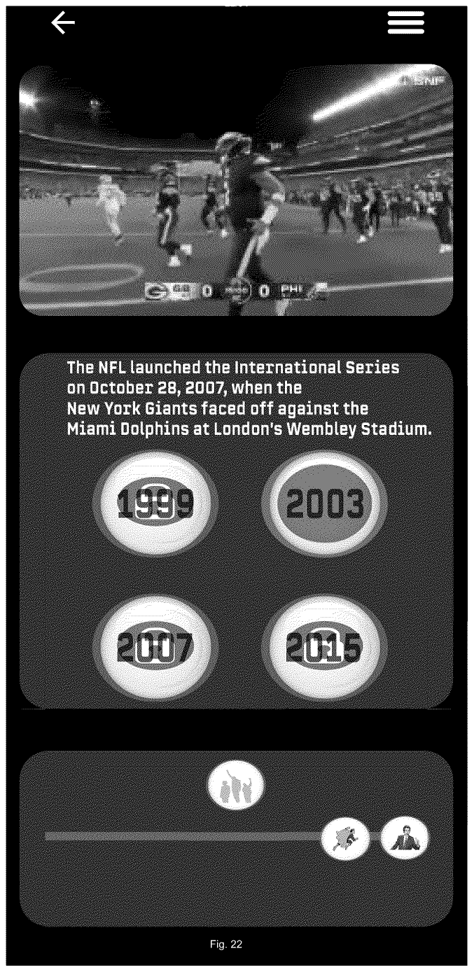

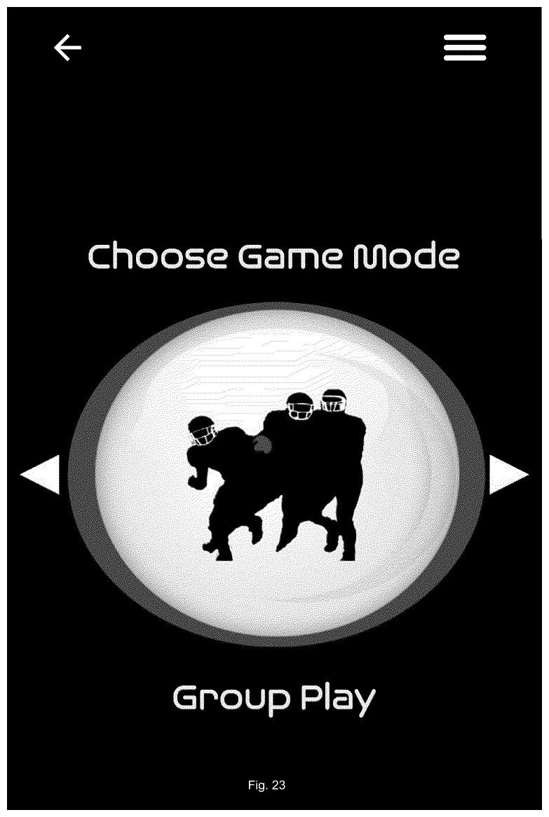

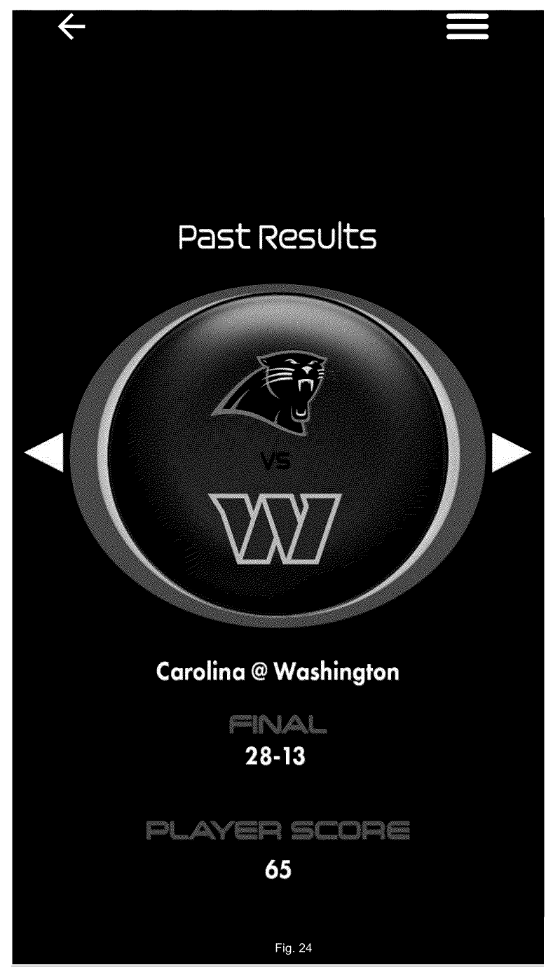

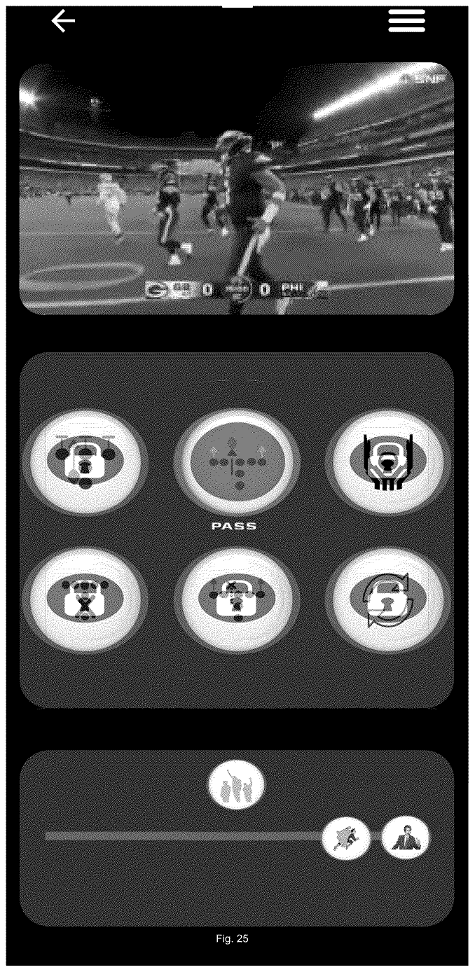

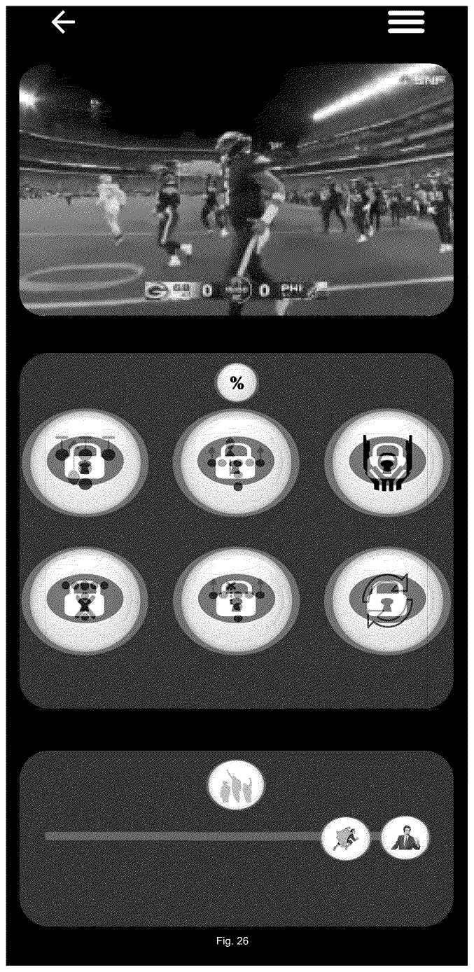

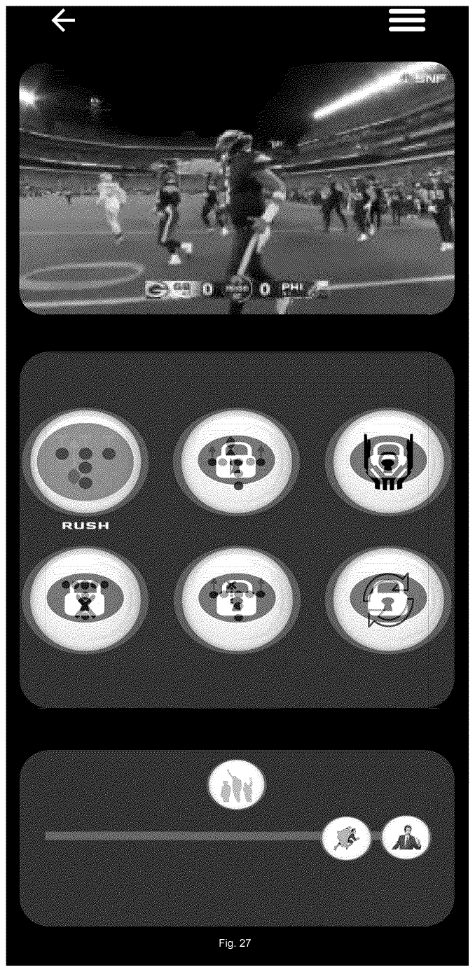

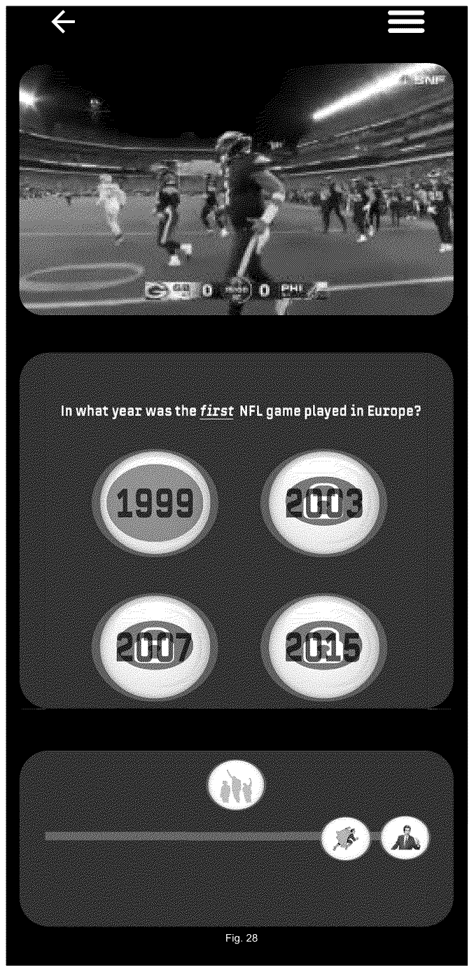

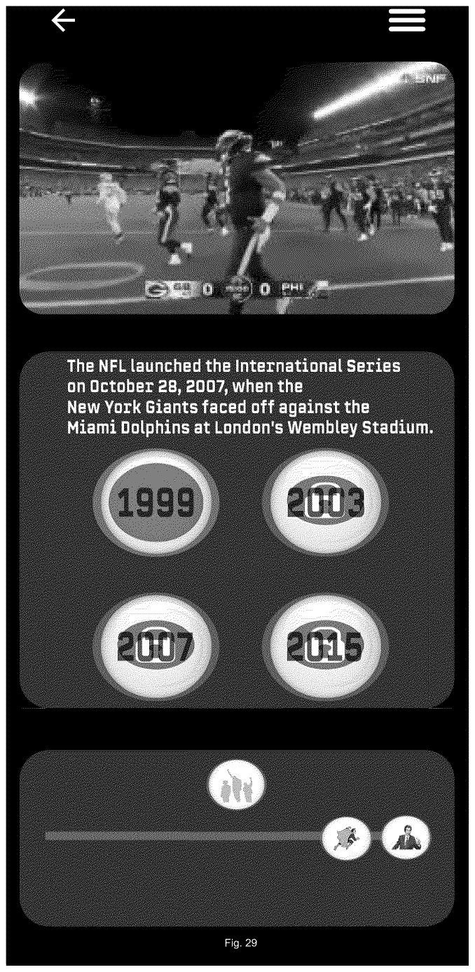

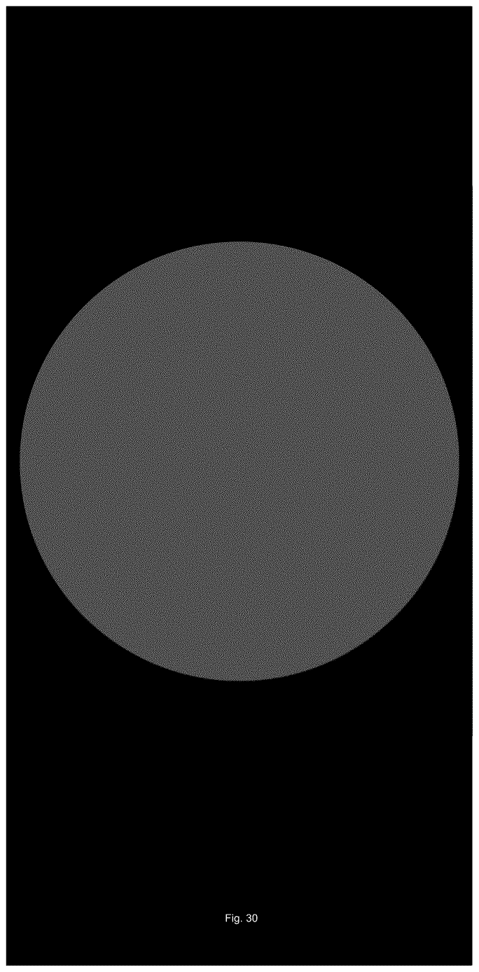

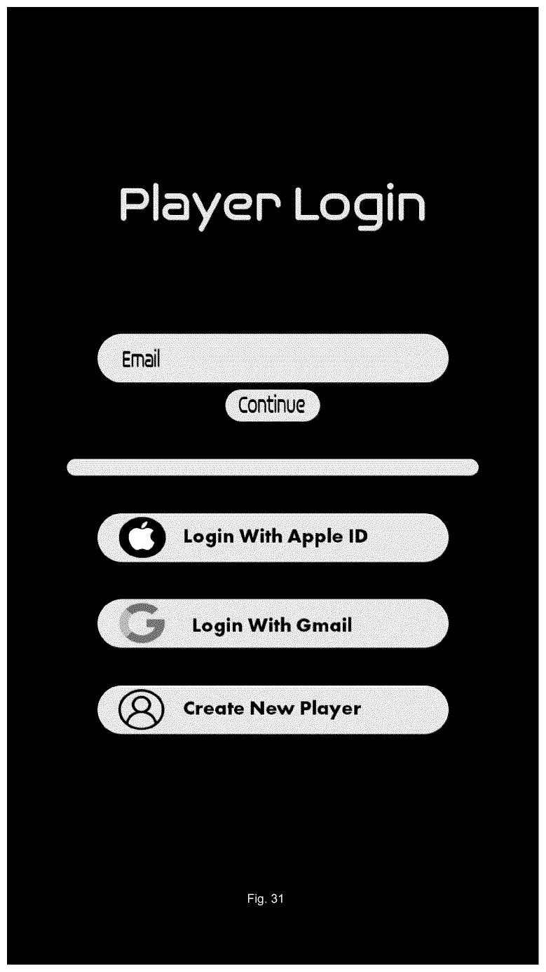

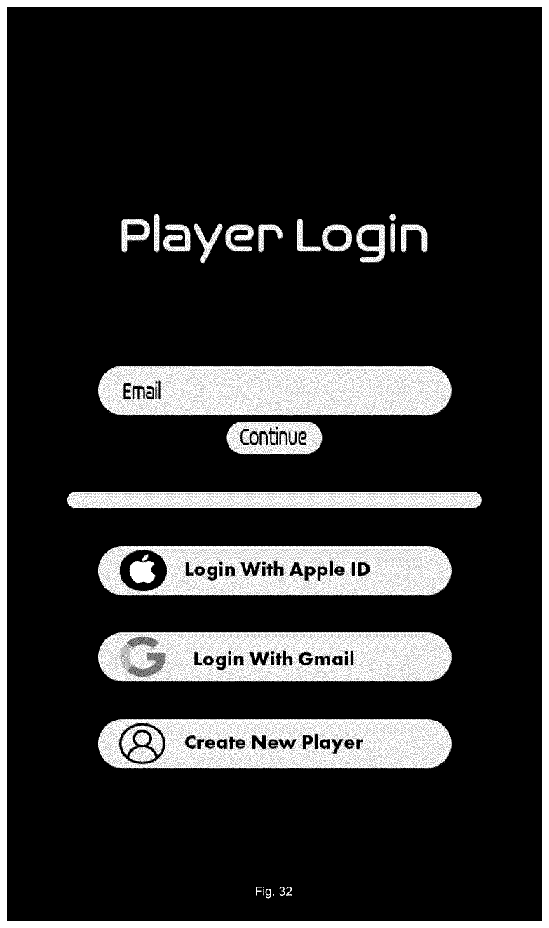

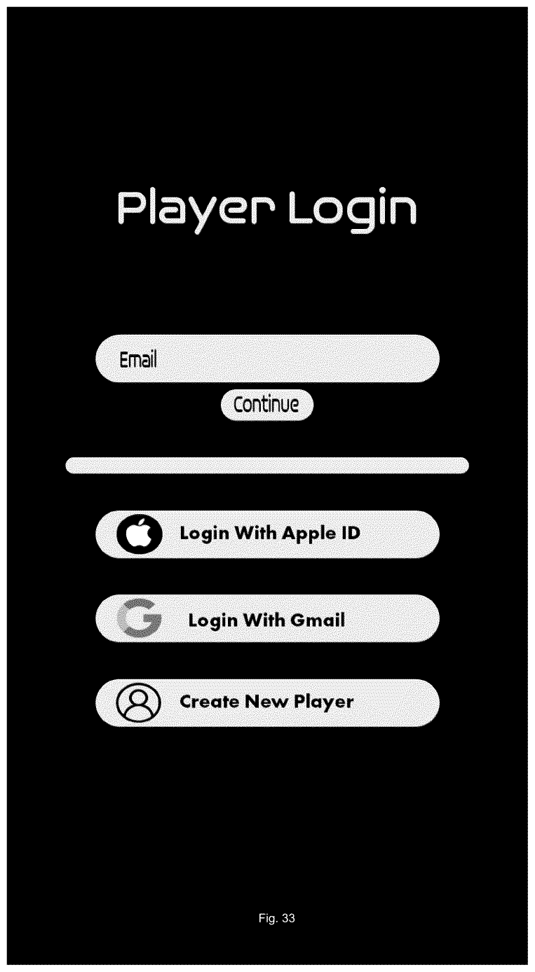

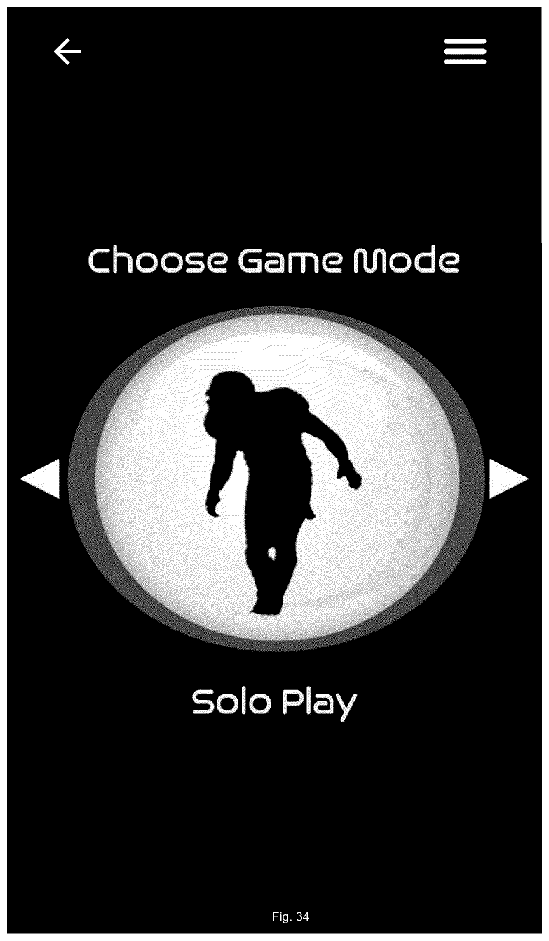

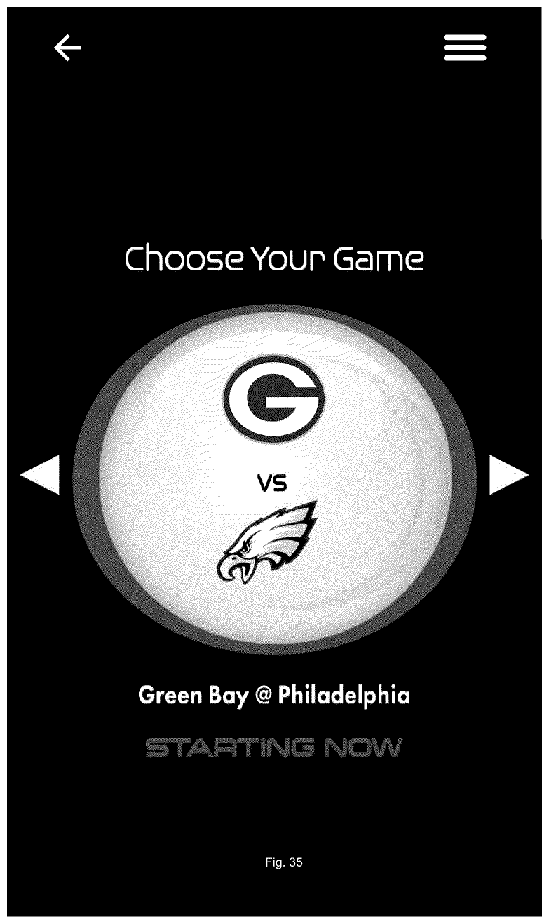

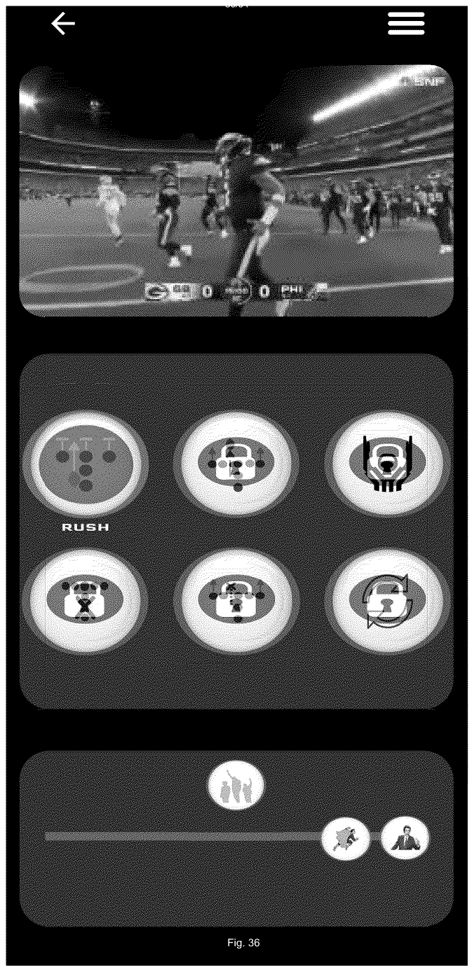

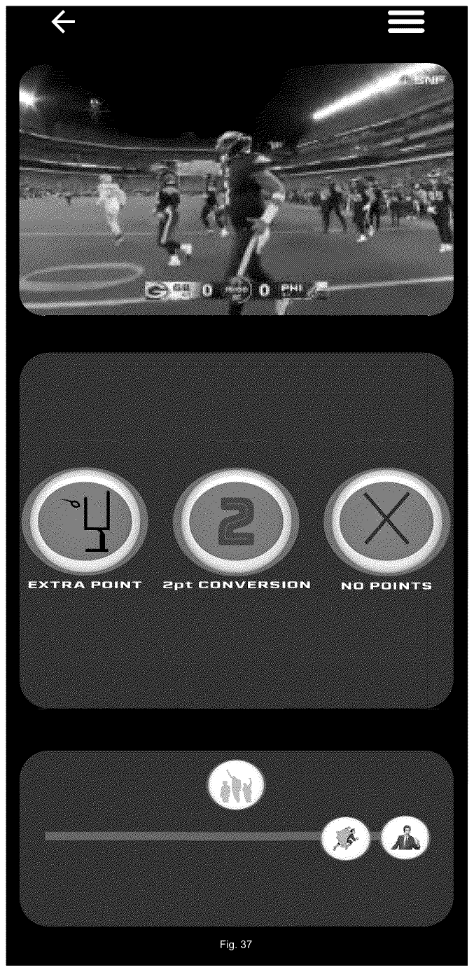

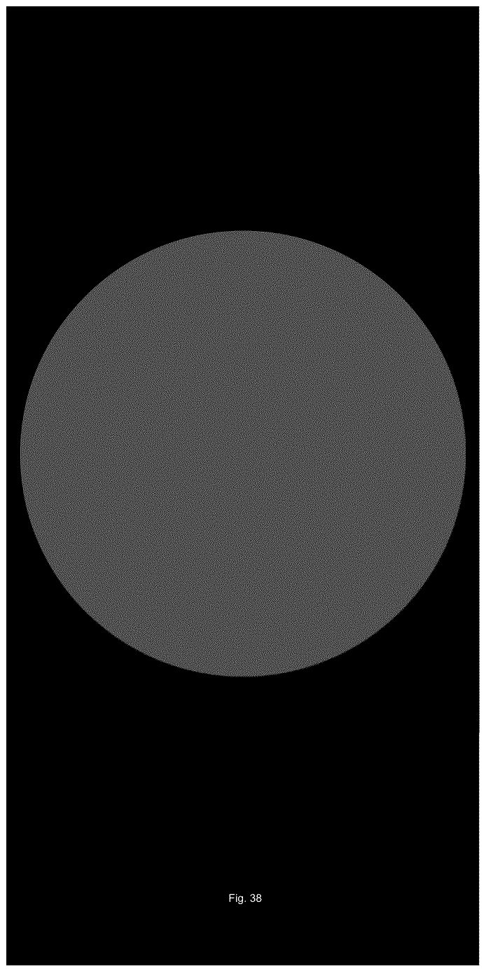

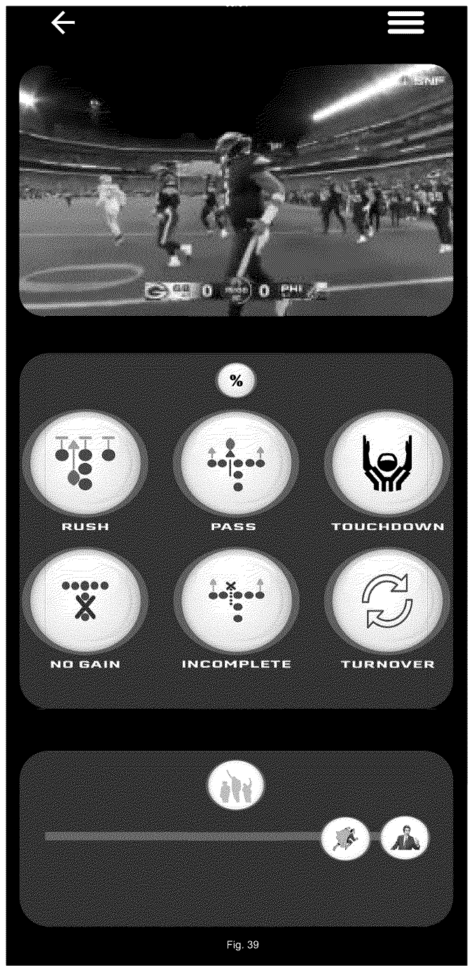

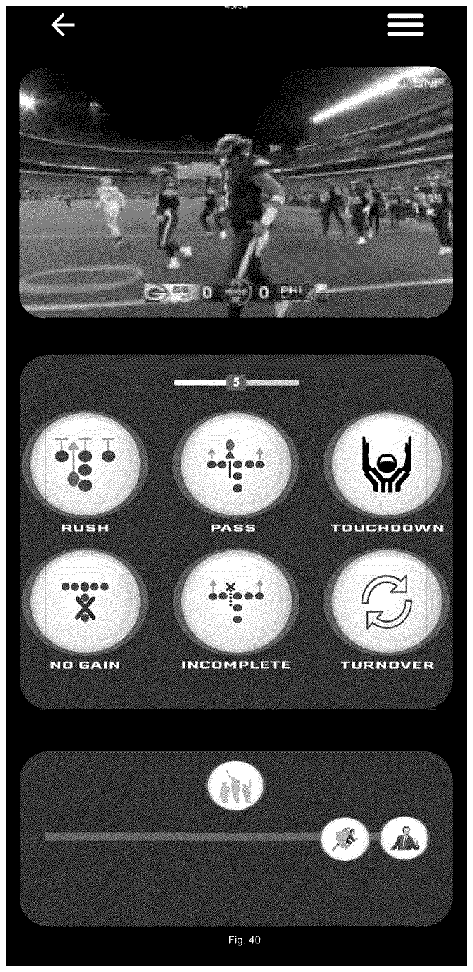

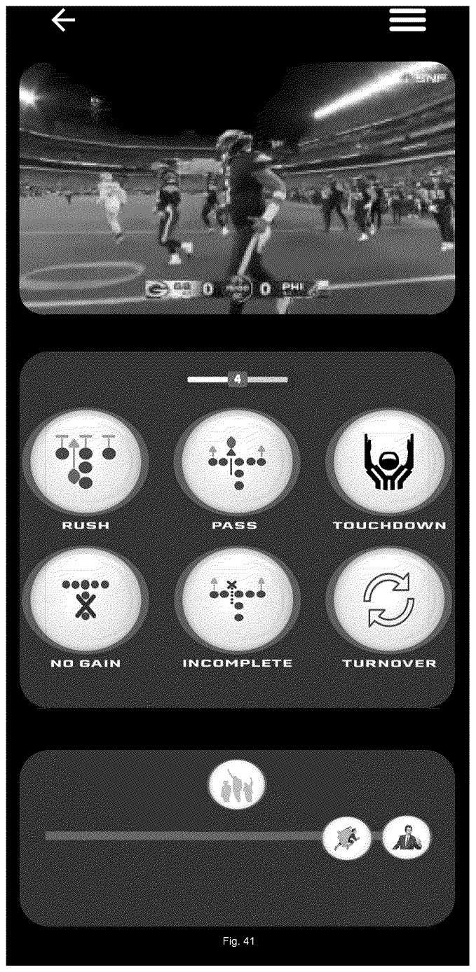

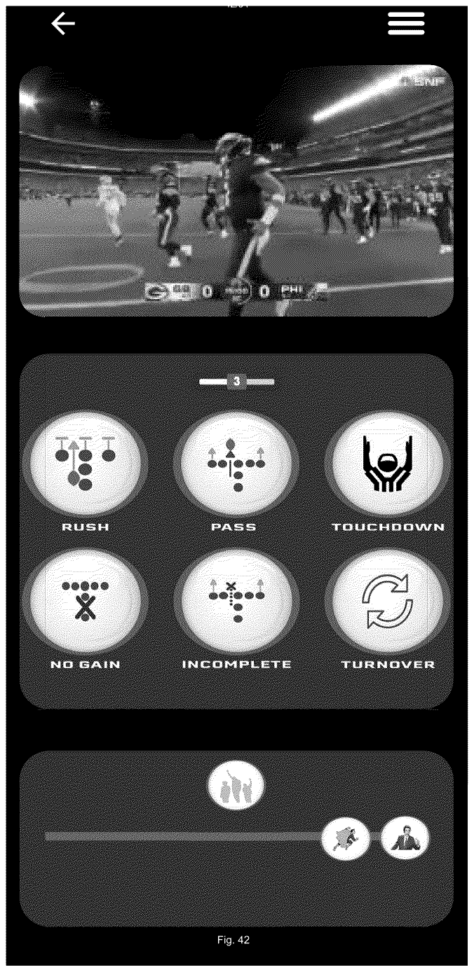

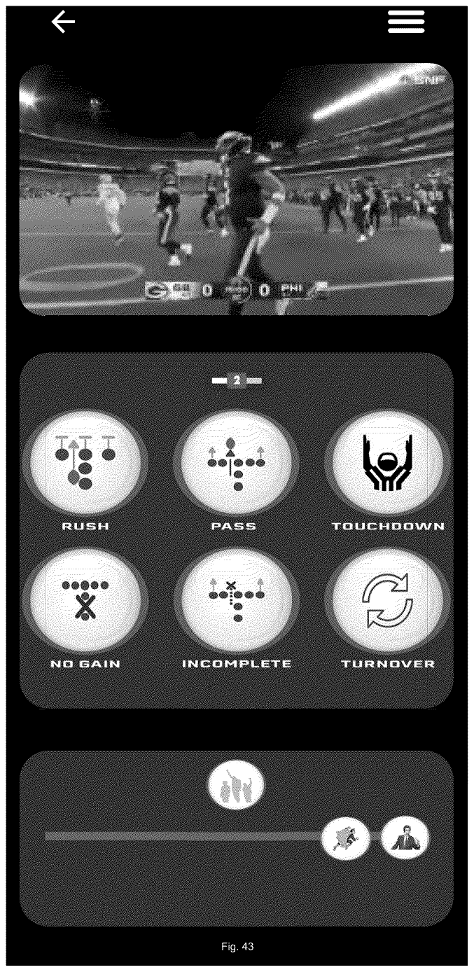

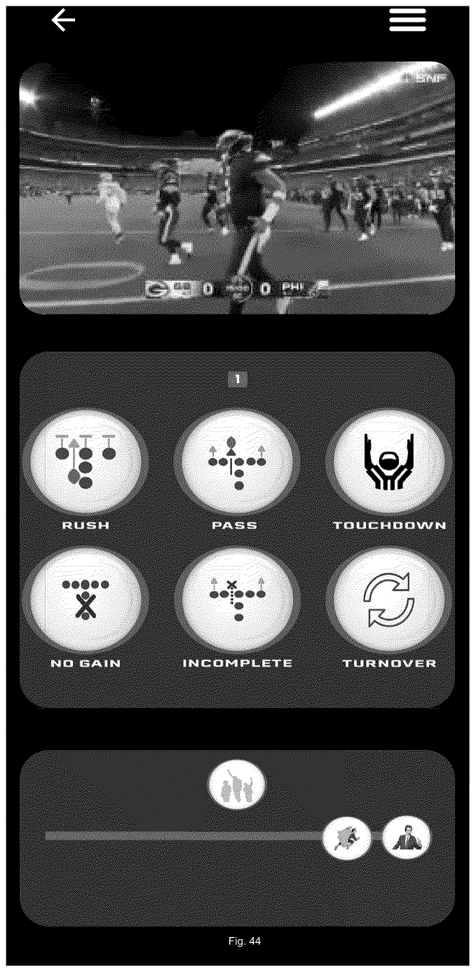

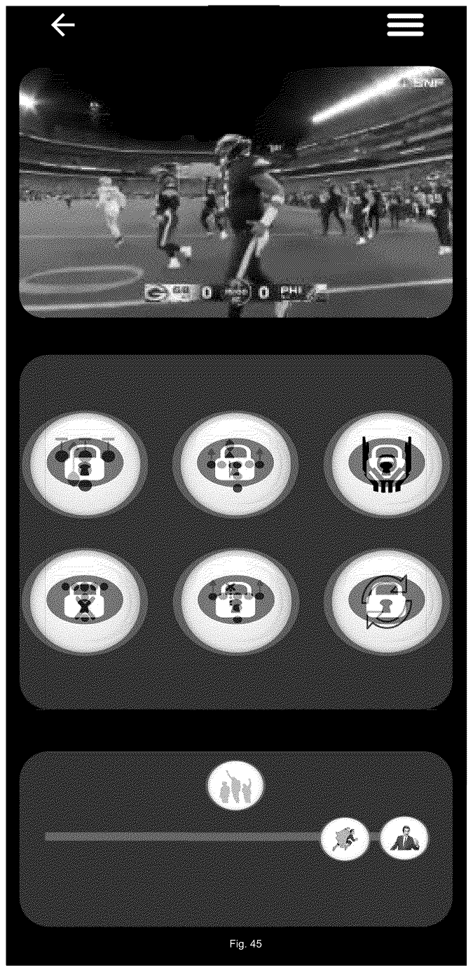

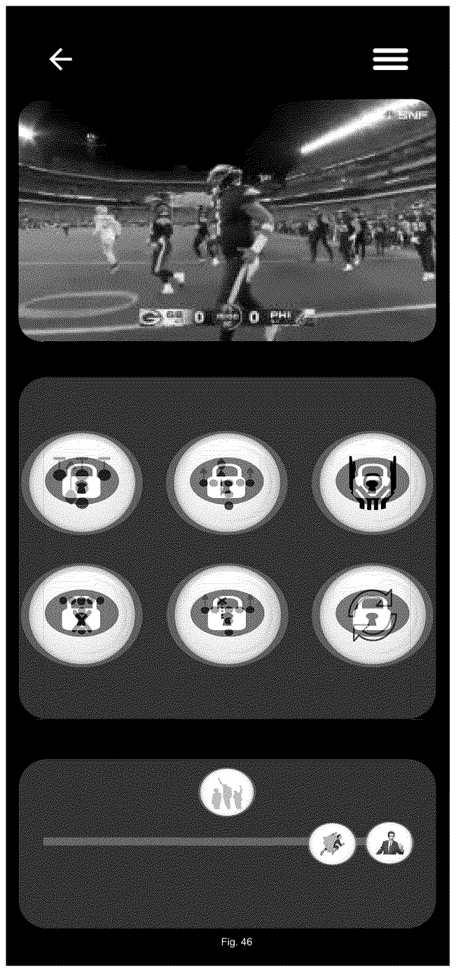

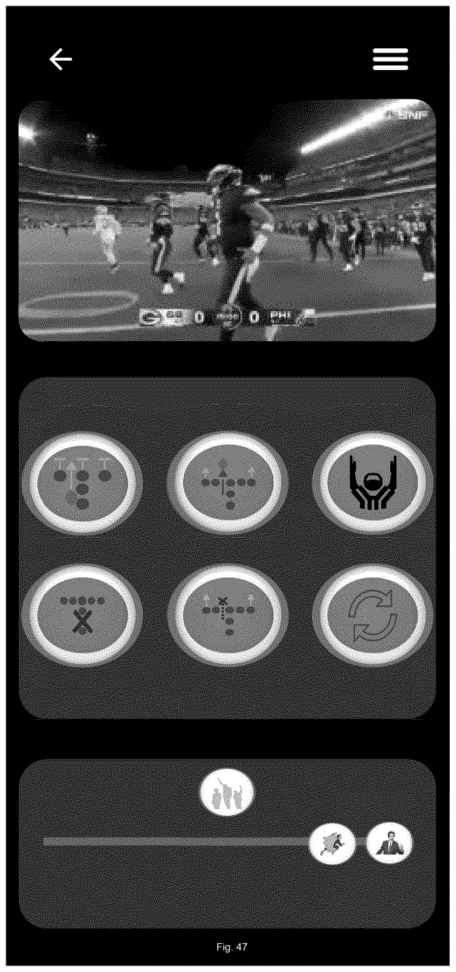

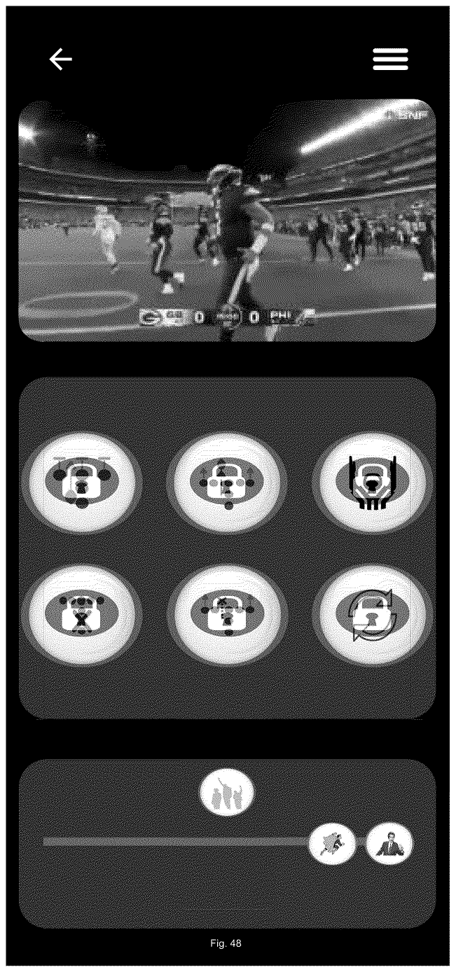

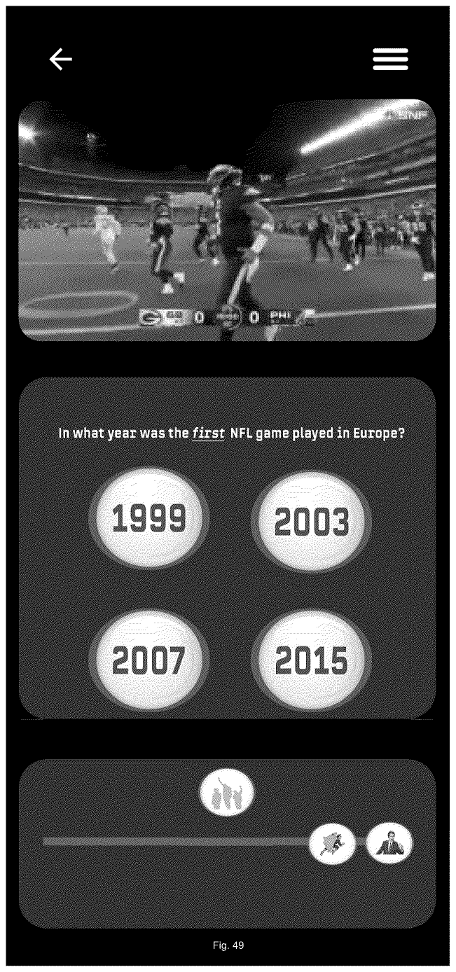

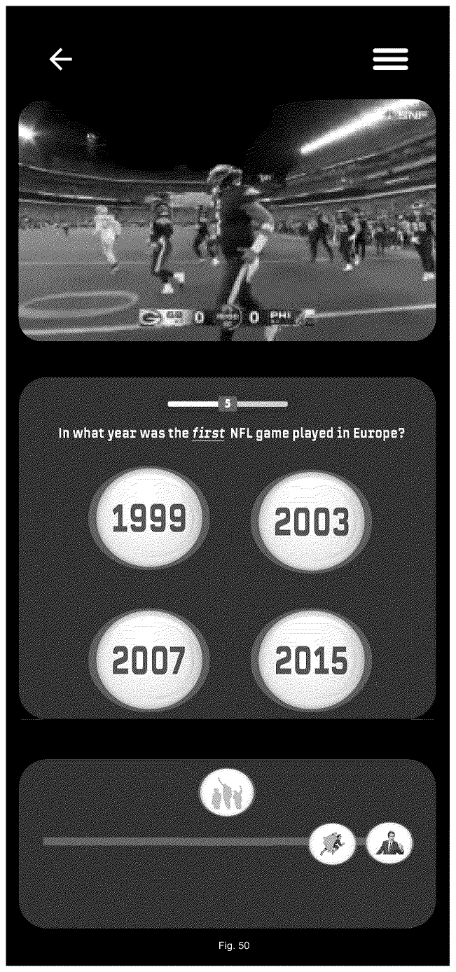

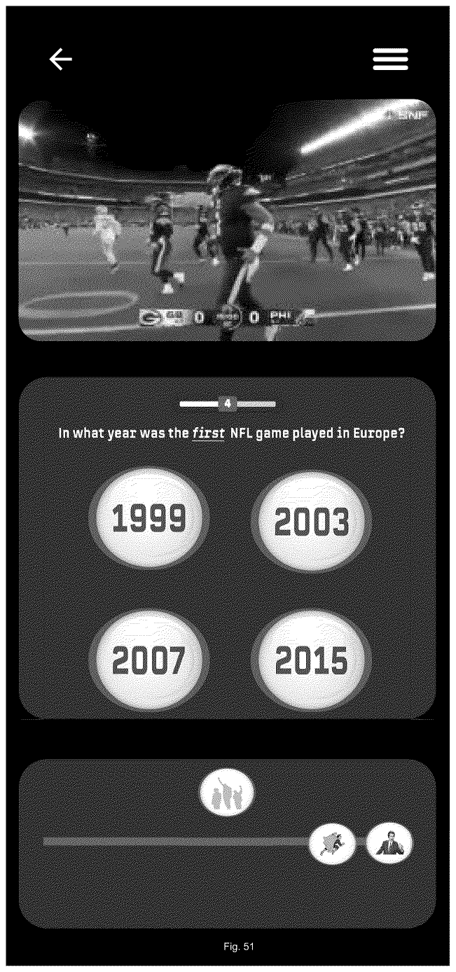

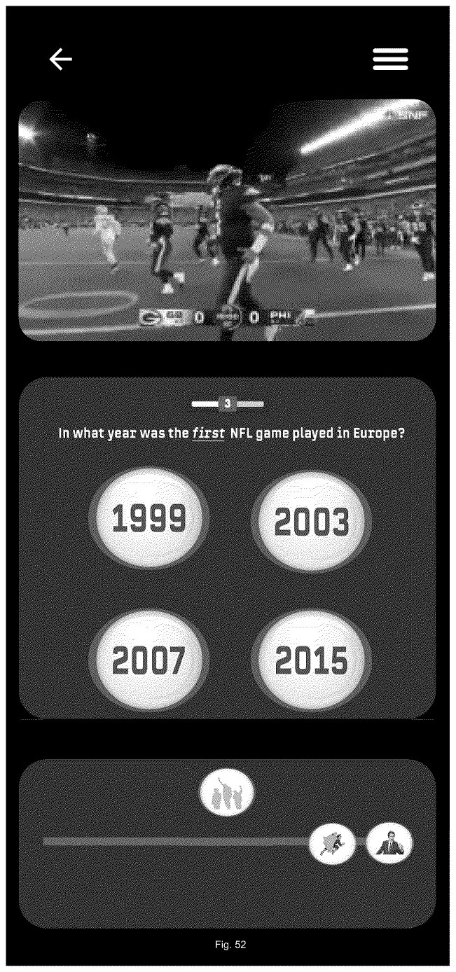

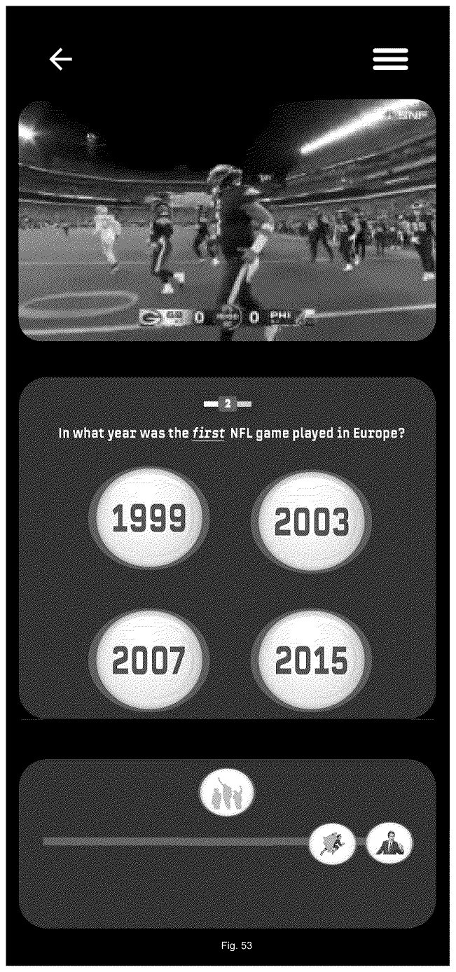

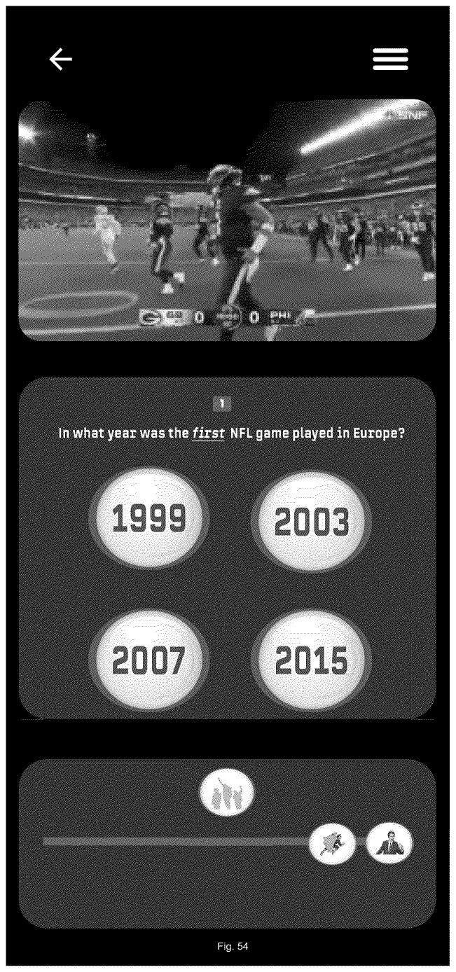

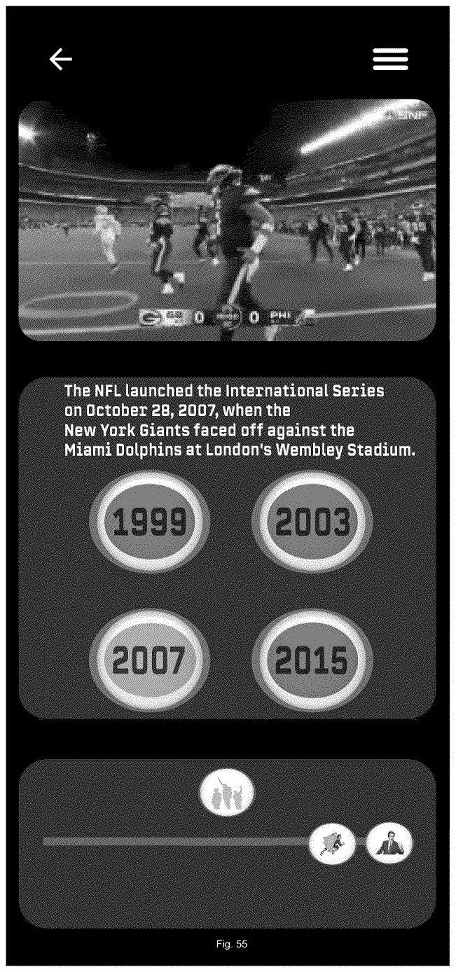

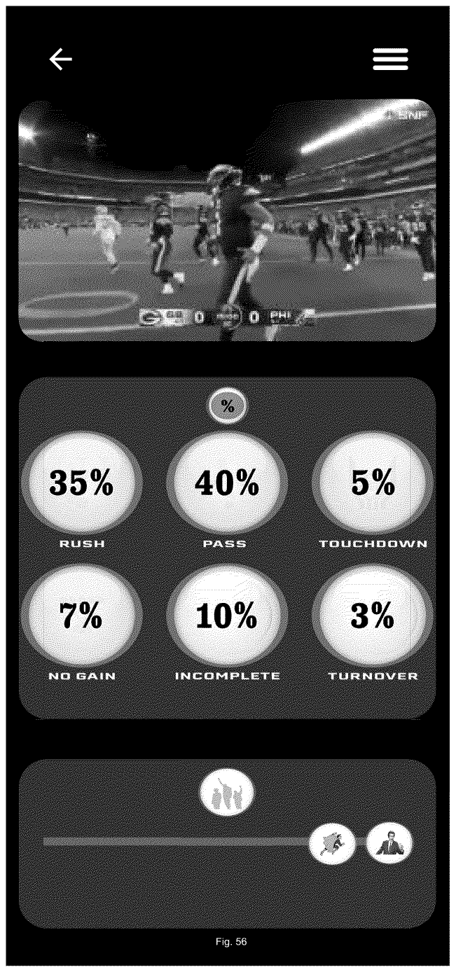

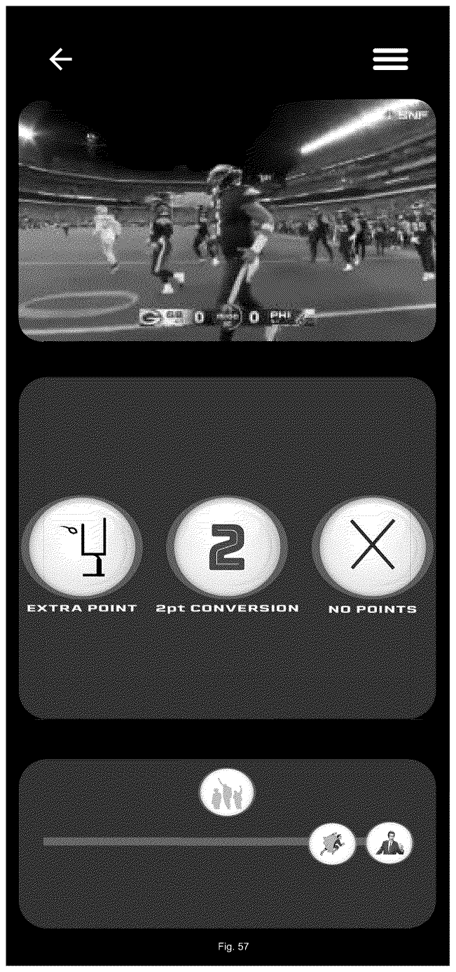

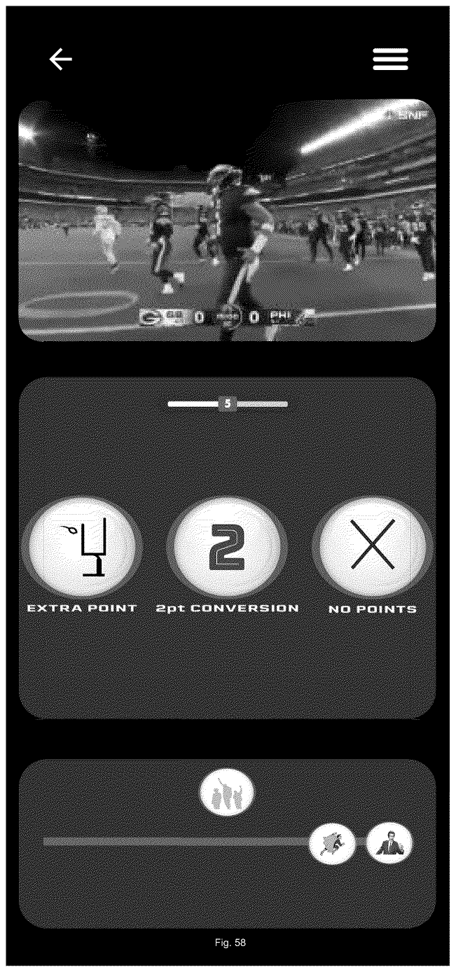

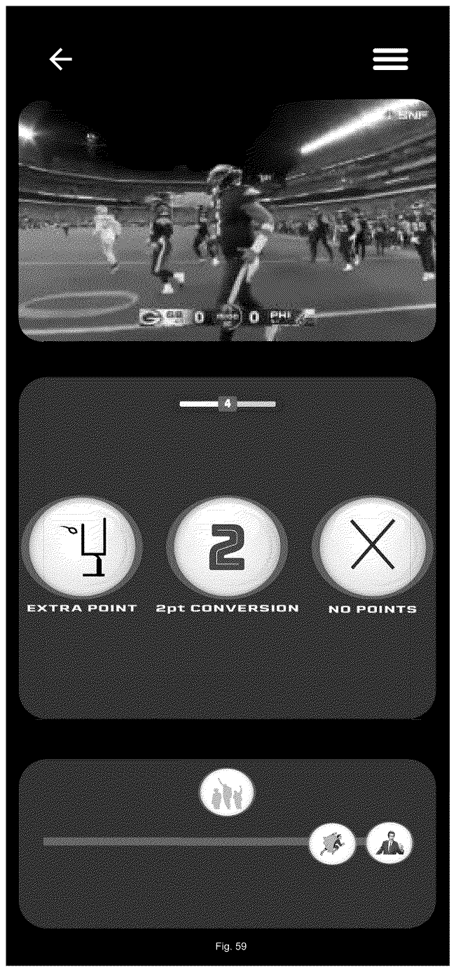

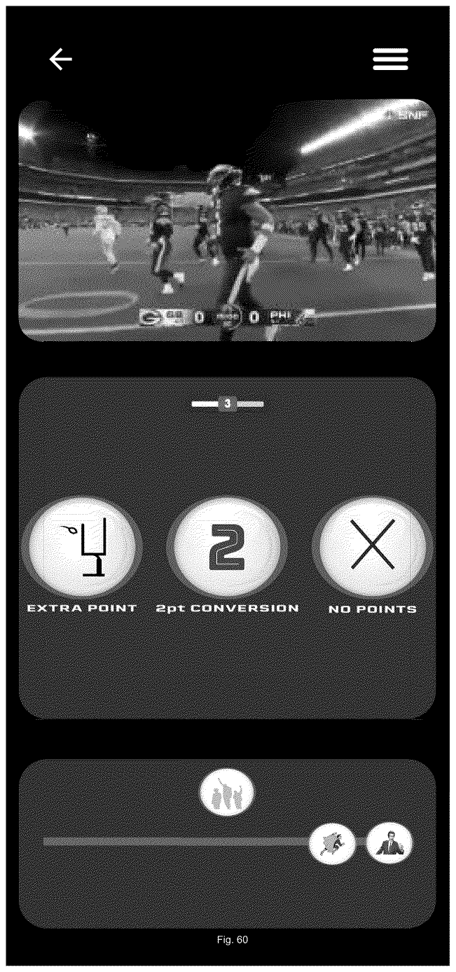

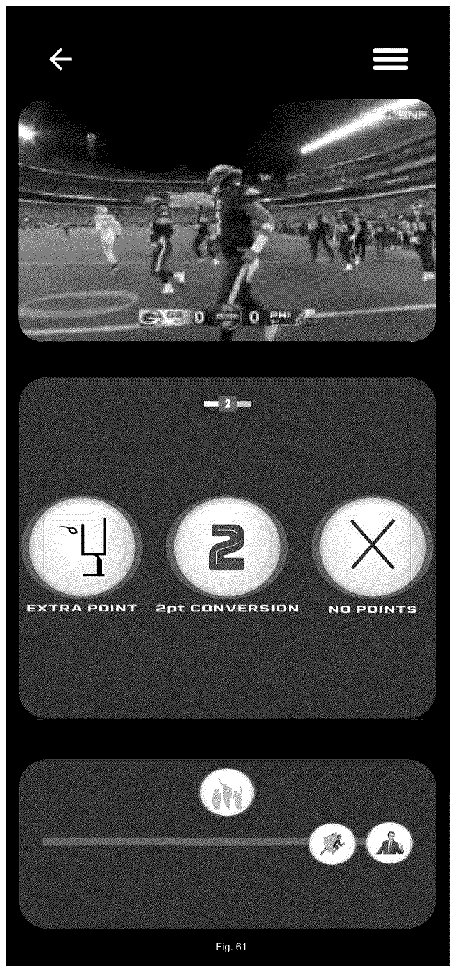

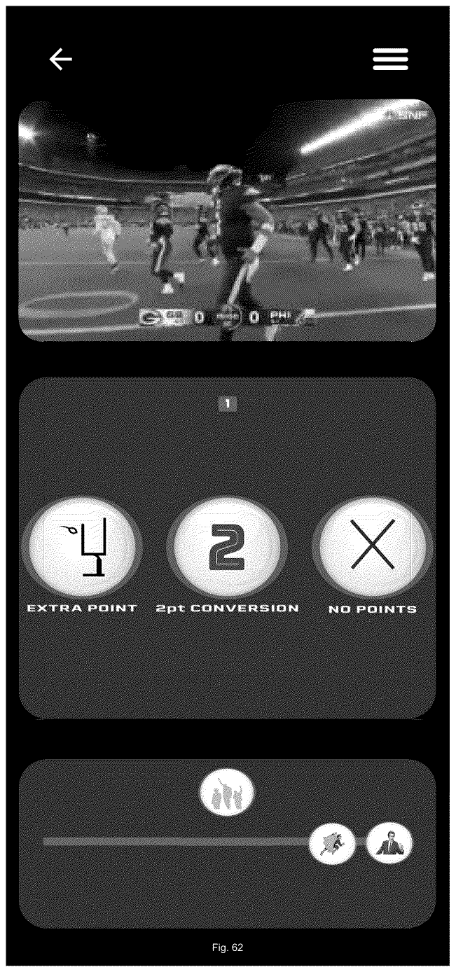

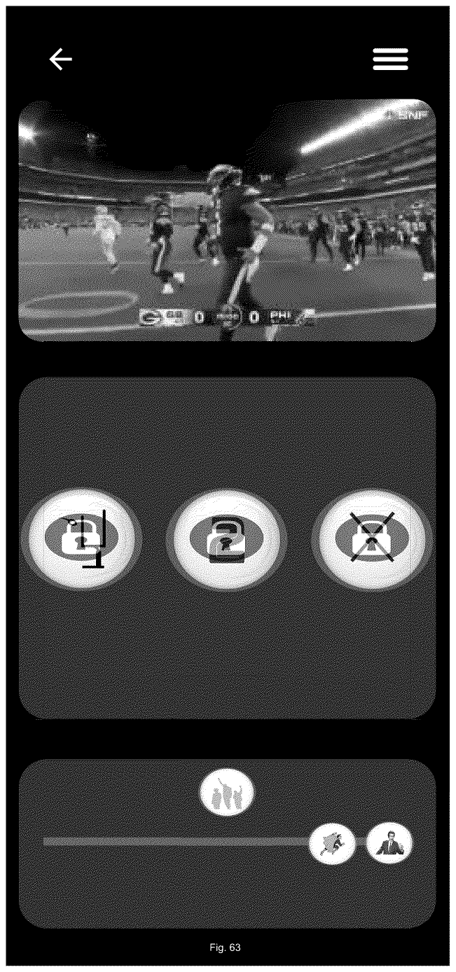

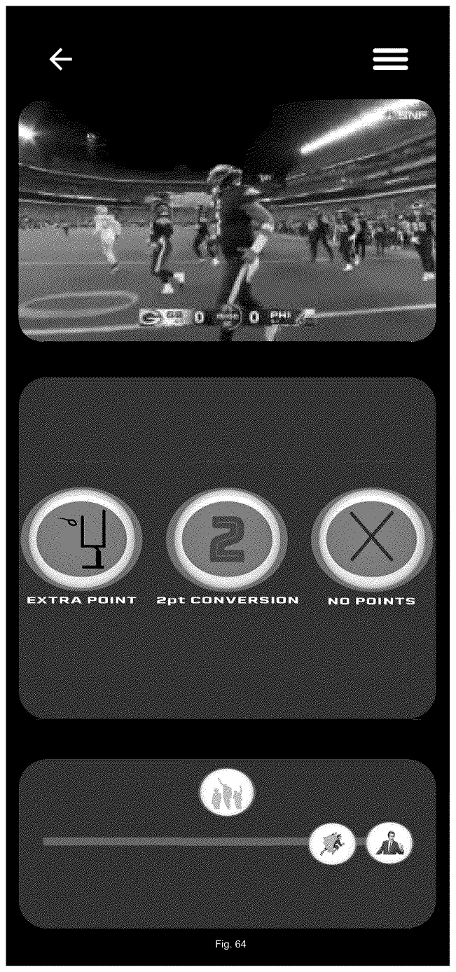

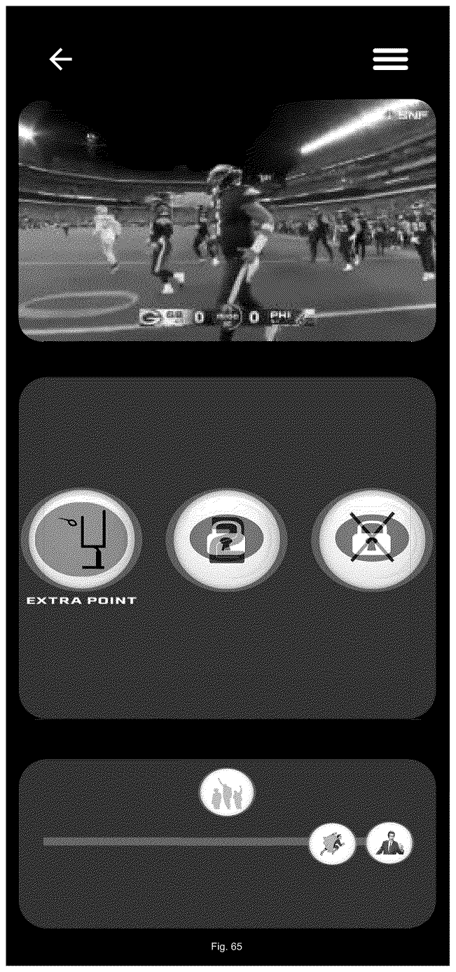

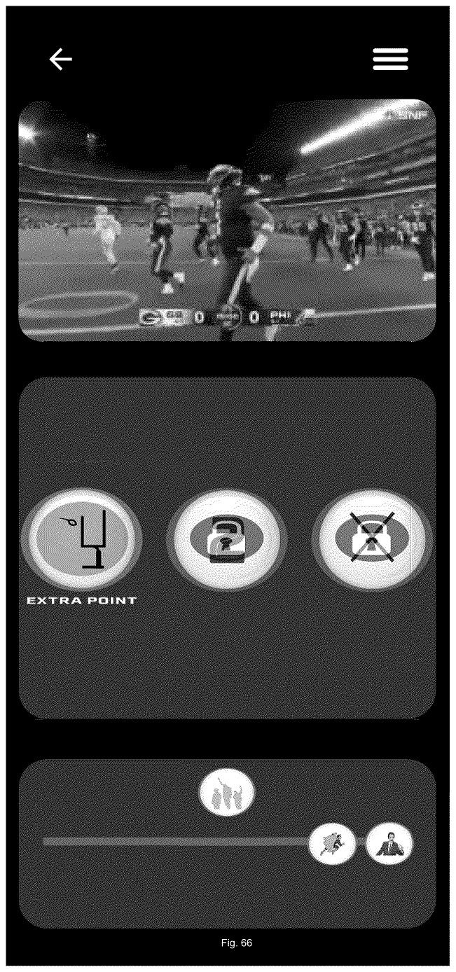

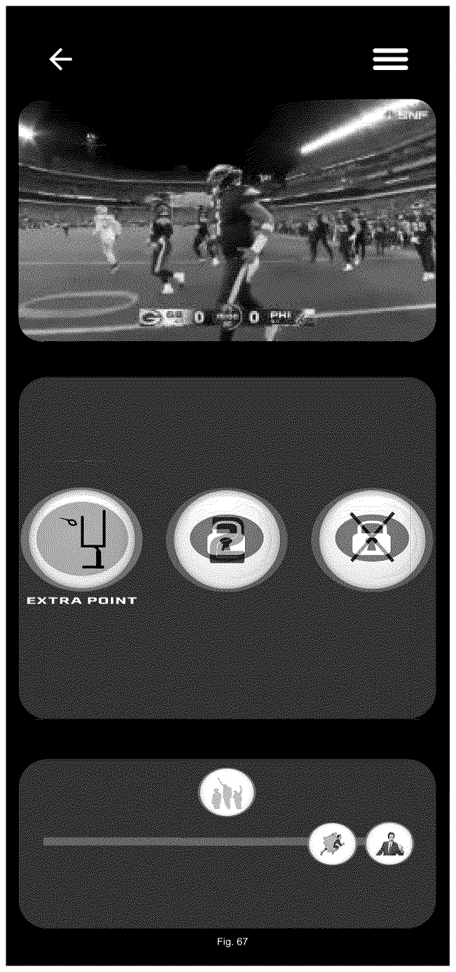

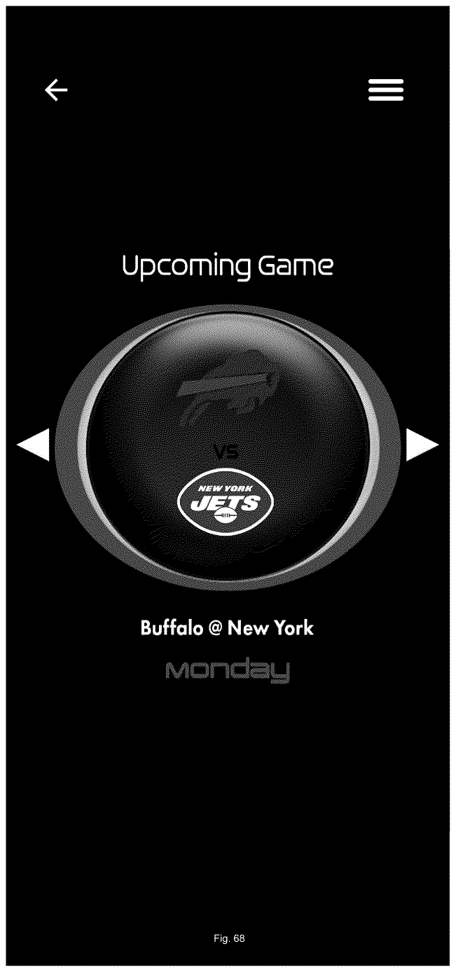

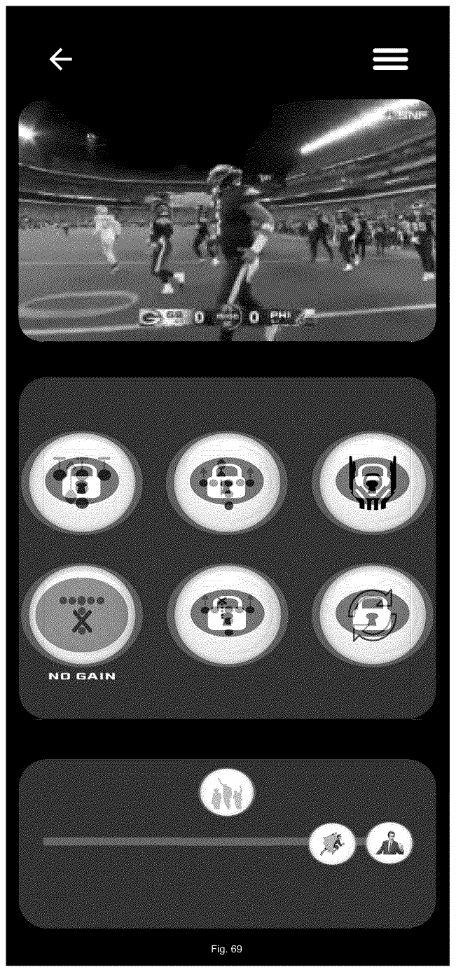

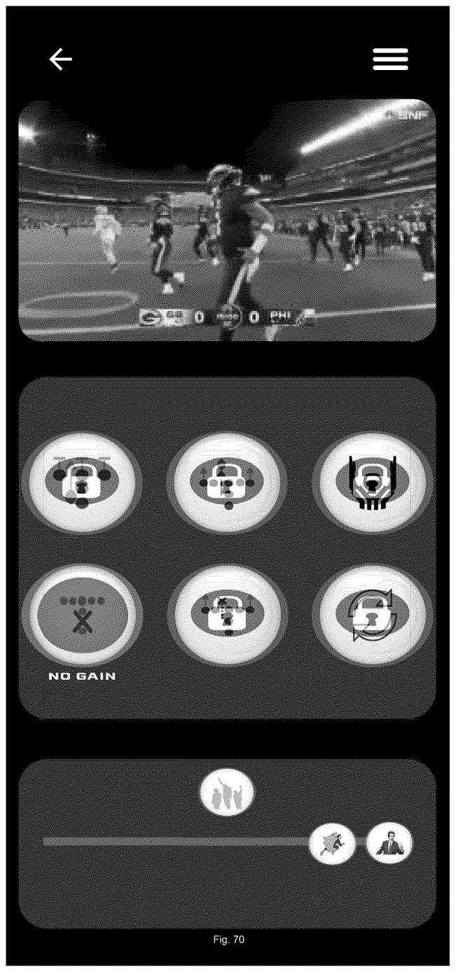

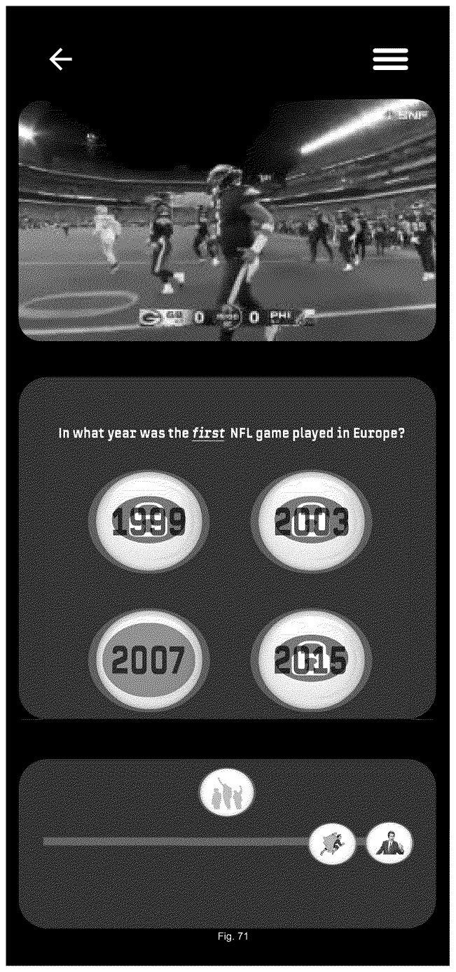

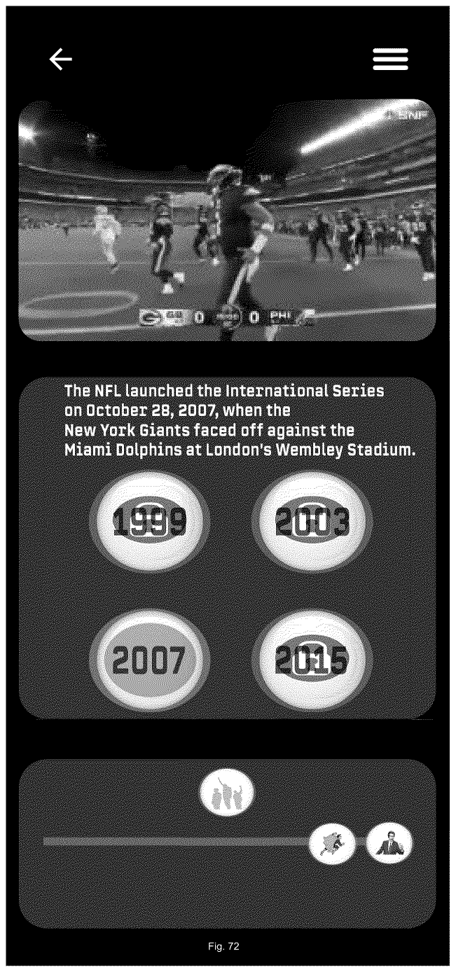

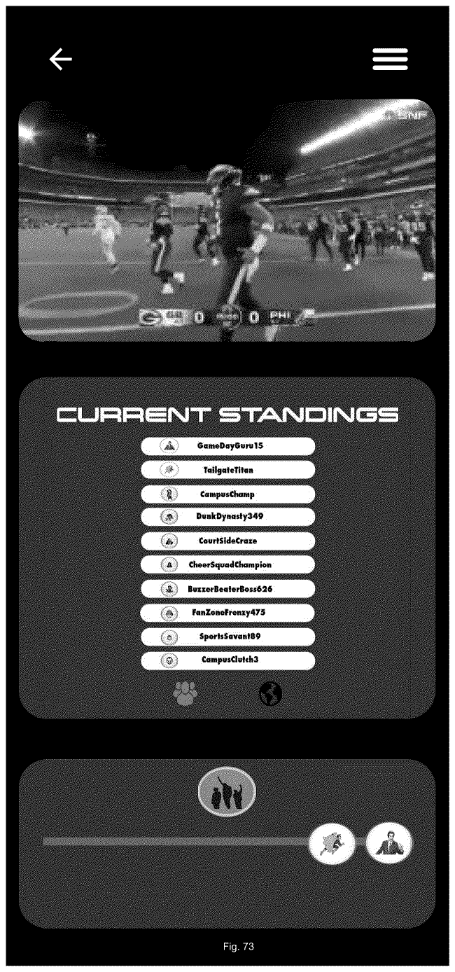

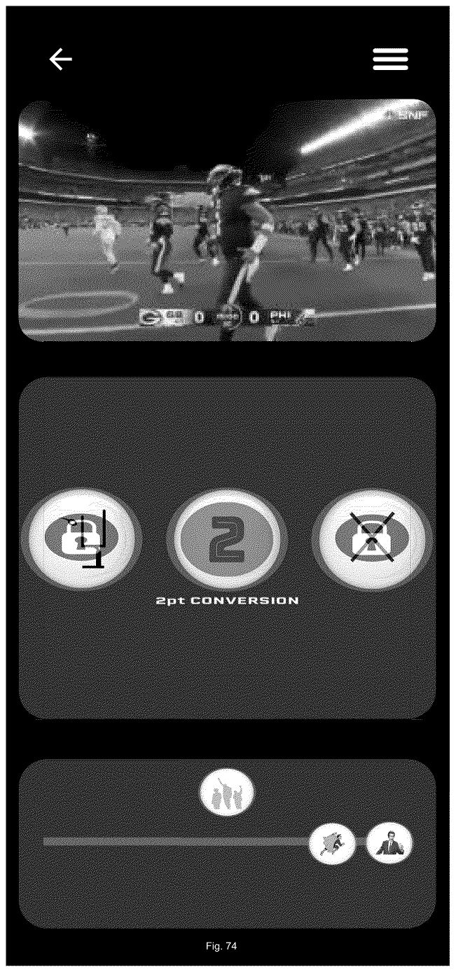

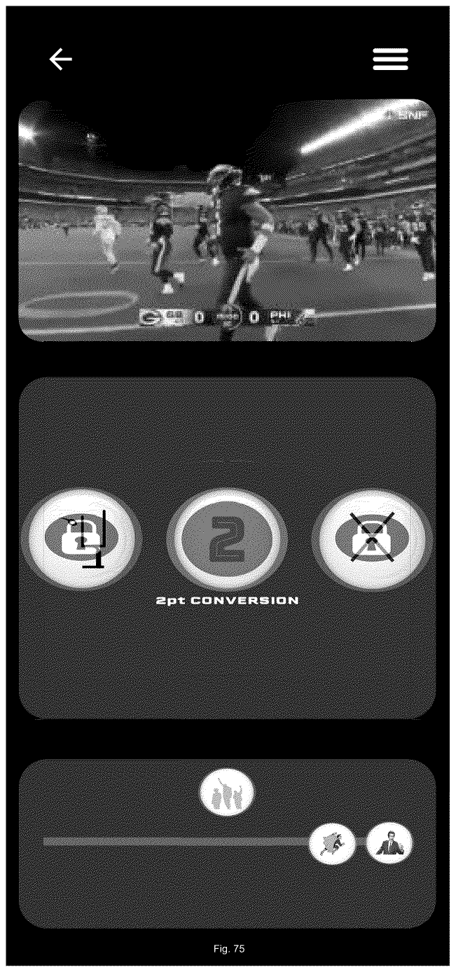

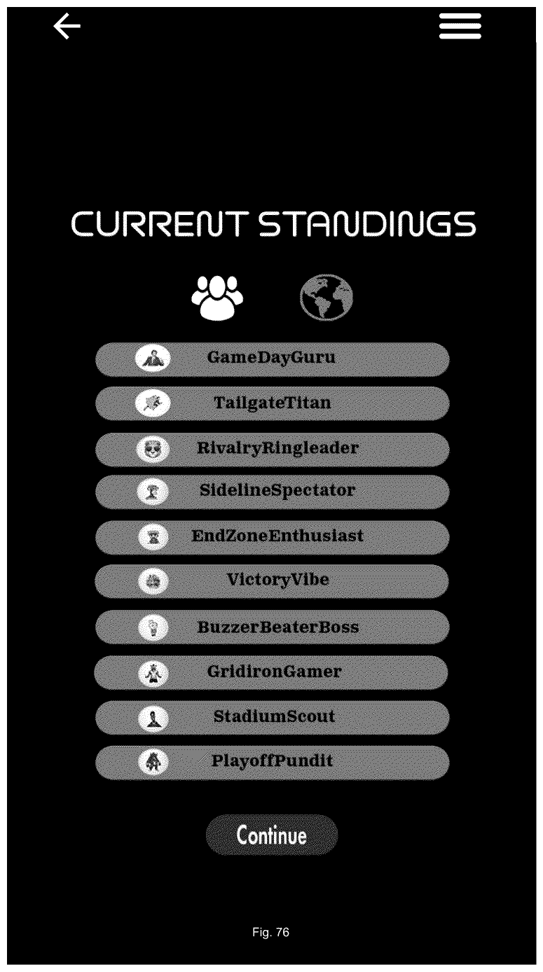

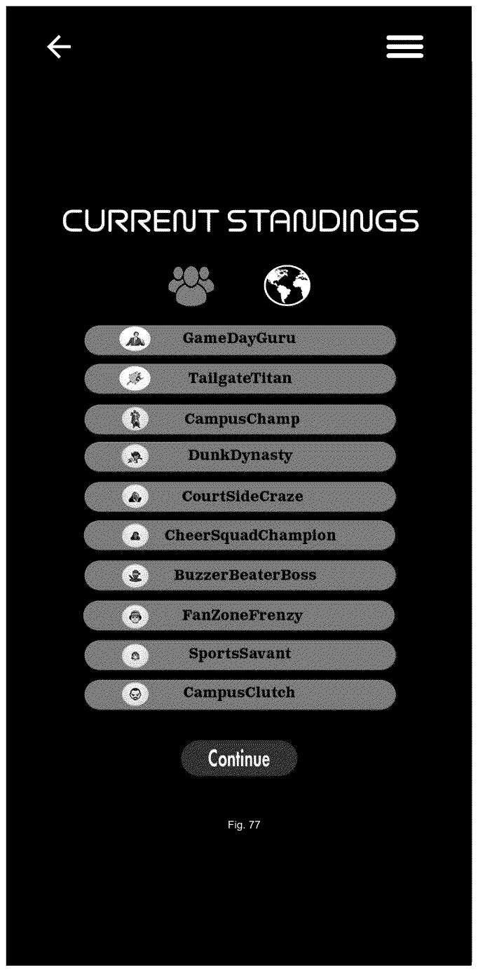

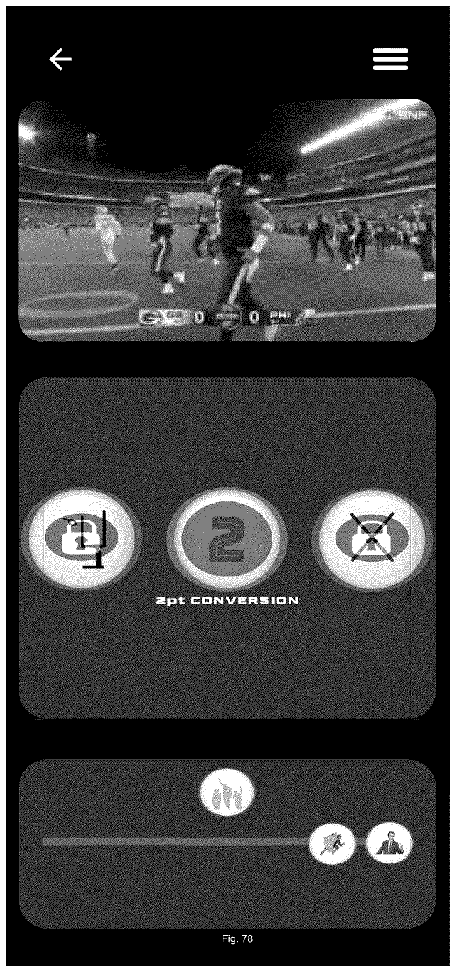

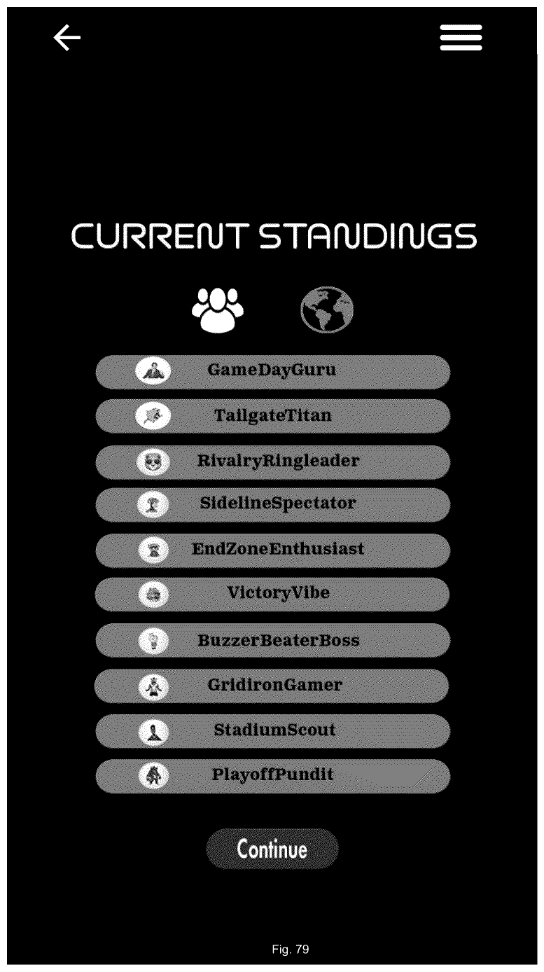

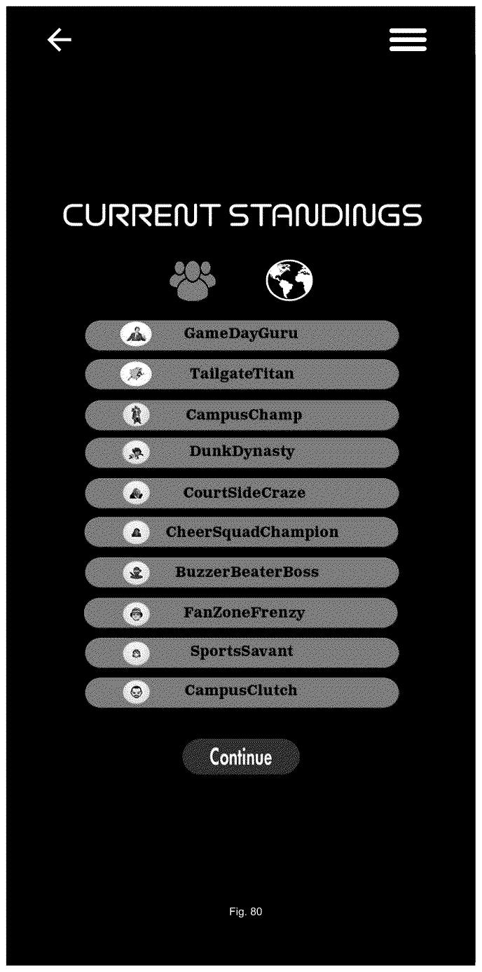

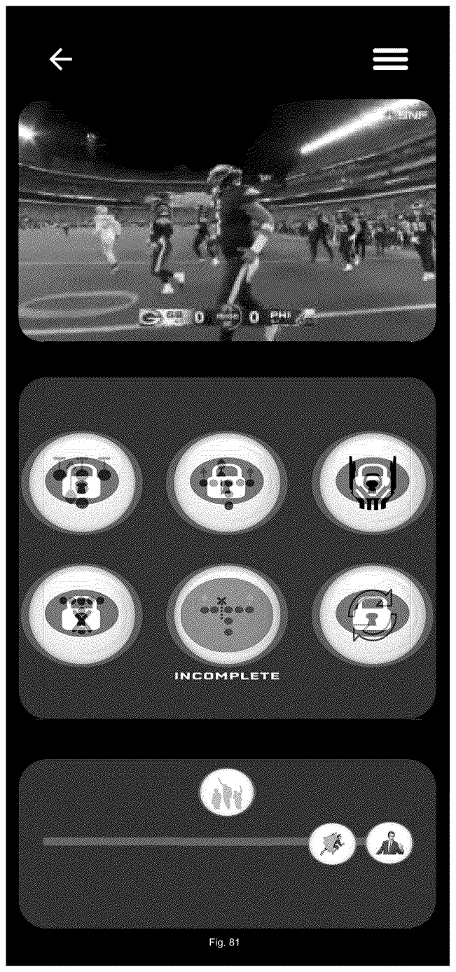

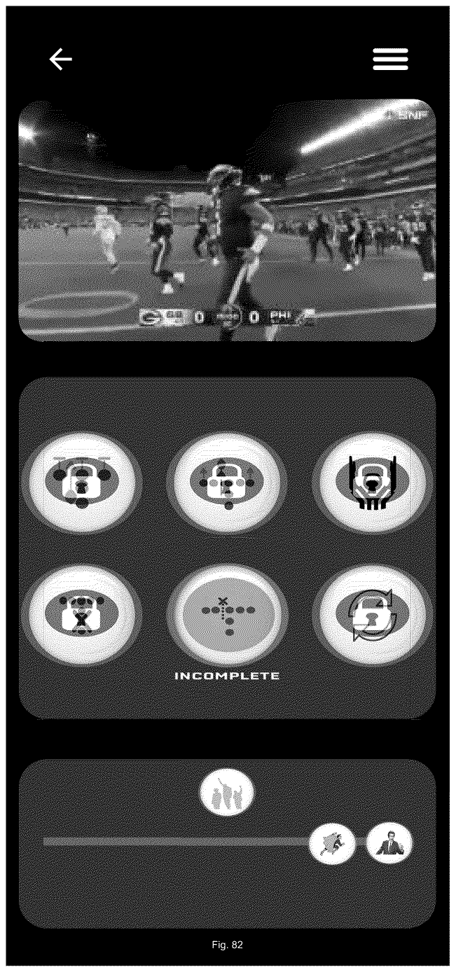

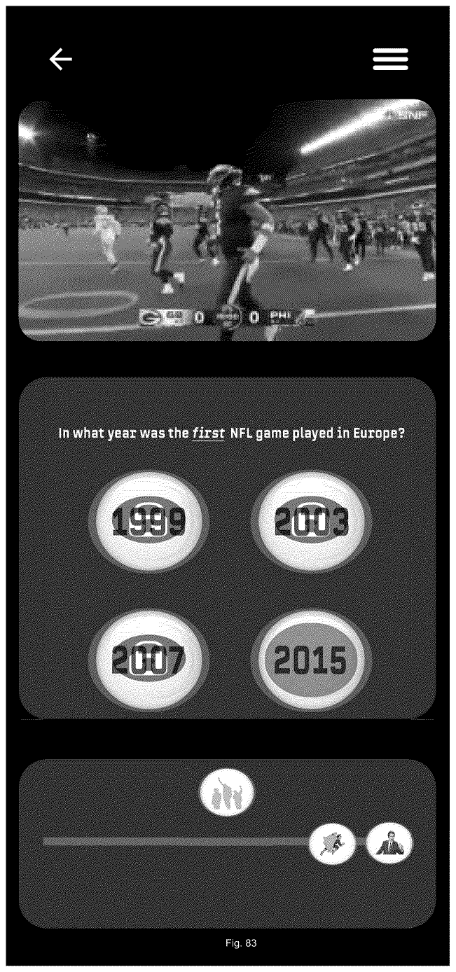

As shown in FIG. 14, a gaming environment is generally designated by the numeral 100. The gaming environment 100 is accessible by a plurality of user communication devices located at or remotely from a live macro-event LE, such as a sporting event. The live macro-event includes a plurality of time separated micro-events, such as individual plays in a sporting event. Each of the user communication devices 100U has a graphical user interface 10 that includes an event viewing section 20 and a prediction input and outcome display section 30.

As shown in FIG. 14, the gaming environment 100 includes a first computer processor 40 having a first non-transitory computer readable storage medium comprising first computer-executable instructions, and having a first algorithm in communication with a broadcast network of the event and configured to download real-time video and audio signals of the live micro-events and convert the real-time video and audio signals into time-stamped signals for real-time display on the event viewing section 20 of the graphical user interface 10. The gaming environment 100 includes a second computer processor 50 having software having a second non-transitory computer readable storage medium comprising second computer-executable instructions, and having a second algorithm having a prediction input module configured to document user predictions of the micro-event entered by the users via the user communication devices 100U, a master platform module and an outcome module. The second algorithm is in communication with the first algorithm for downloading real-time outcomes of the micro-event. The master platform is configured to calculate scoring of the user predictions of the live micro-events based upon the real-time outcomes of the live micro-events and display the outcomes and scoring on the prediction input and outcome display section 30 of the graphical user interface 10, before the start of a subsequent live micro-event.

In some embodiments, the first algorithm generates input time-stamp limits to a count-down clock in the prediction input module, the input time-stamp limits automatically close a window of time for entry of the user predictions.

There is also disclosed herein a method for facilitating real-time comparison of outcome predictions for live micro-events within a live macro-event. The method includes digitalizing a live macro-event into a plurality of discrete digital components. Each of the discrete digital components includes a time component that corresponds to at least one information component. The method includes defining a plurality micro-events each of which include a micro-event time cap that corresponds to a prediction score. The method includes receiving a first micro-event prediction and a second micro-event prediction; and comparing the first micro-event prediction to the live micro-event outcome.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A system for multiple players to predict outcomes of live micro-events in a macro-event and for comparing predictions to actual outcomes of the live micro-events, the system comprising:
(a) a video source configured to record and transmit live video signals of the micro-events;
(b) a cloud based platform having:
a first non-transitory computer readable storage medium comprising first computer-executable instructions;
a second non-transitory computer readable storage medium comprising at least one backend server and second computer-executable instructions;
a video signal processor in communication with the video source and comprising at least one video encoding and distribution module;
(c) a management application comprising a broadcast studio, a game management, a user management, and a platform configuration, the management application being in communication with:
(i) the at least one backend server for sharing real-time and pre-programed information back and forth between the management application and the at least one backend server; and
(ii) the video signal processor for transmitting the live video signals back and forth between the video signal processor and the management application; and
(d) a plurality of user communication devices each being in communication with the at least one video encoding and distribution module and each of the plurality of user communication devices having:
(I) a graphical user interface comprising an event viewing section and a prediction input and outcome display section, the prediction input and outcome display section being configured to receive user predictions of a plurality of the micro-events before the micro-event starts and for displaying the outcomes of the plurality of micro-events before the start of a subsequent live micro-event;
(II) a video player in communication with the event viewing section;
(III) a game controller in communication with the prediction input and outcome display section;
(IV) a user results module in communication with the prediction input and outcome display section, the user results module being configured to calculate and display user scores based on a comparison of the user predictions to the outcomes of the plurality of micro-events; and
(V) a data and predictions module in communication with the prediction input and outcome display section.

2. The system of claim 1, comprising:
a primary display in communication with the at least one video encoding and distribution module for receiving the live video signals and displaying the live macro-event.

3. The system of claim 1, comprising:
a plurality of data feeds in communication with the first non-transitory computer readable storage medium for transmitting supplementary real-time information to the first non-transitory computer readable storage medium.

4. The system of claim 1, wherein the first algorithm generates input time-stamp limits to a count-down clock in the prediction input module, the input time-stamp limits automatically close a window of time for entry of the user predictions.

5. The system of claim 1, wherein the prediction input and outcome display section is configured to receive and process the users predictions for at least one of winner of a segment of a macro-event and a winner of the entire macro-event.

6. The system of claim 1, wherein the macro-event is a football game and the prediction input and outcome display section is configured to receive and process the users predictions for at least one over/under scores for a game quarter, field position after kick-off, type of play, touchdown, turnover, incomplete pass, no gain, punt, field goal attempt result, and points achieved after a touchdown.

7. The system of claim 1, wherein the graphical user interface comprises a listing of a plurality of users'points resulting from the user predictions.

8. A system for multiple players predicting outcomes of live micro-events in a macro-event and for comparing predictions to actual outcomes of the live micro-events, the system comprising:
a gaming environment that is accessible by a plurality of user communication devices located remotely from the live macro-event and each of the user communication devices having a graphical user interface comprising an event viewing section and a prediction input and outcome display section;
a first computer processor having a first non-transitory computer readable storage medium comprising first computer-executable instructions, and having a first algorithm in communication with a broadcast network of the event and configured to download real-time video and audio signals of the live micro-events and convert the real-time video and audio signals into time-stamped signals for real-time display on the event viewing section of the graphical user interface;
a second computer processor having software having a second non-transitory computer readable storage medium comprising second computer-executable instructions, and having a second algorithm having a prediction input module configured to document user predictions of the micro-event entered by the users via the user communication devices, a master platform module and an outcome module, the second algorithm being in communication with the first algorithm for downloading real-time outcomes of the micro-event, the master platform being configured to calculate scoring of the user predictions of the live micro-events based upon the real-time outcomes of the live micro-events and display the outcomes and scoring on the prediction input and outcome display section of the graphical user interface, before the start of a subsequent live micro-event.

9. The system of claim 8, wherein the first algorithm generates input time-stamp limits to a count-down clock in the prediction input module, the input time-stamp limits automatically close a window of time for entry of the user predictions.

10. A method for facilitating real-time comparison of outcome predictions for live micro-events within a live macro-event, the method comprising:
digitalizing a live macro-event into a plurality of discrete digital components, each of the discrete digital components comprising a time component, the time component corresponding to at least one information component;
defining a plurality micro-events, each micro-event of the plurality of micro-events comprising a micro-event time cap, the micro-event time cap corresponding to a prediction score;
receiving a first micro-event prediction and a second micro-event prediction; and
comparing the first micro-event prediction to the live micro-event outcome.

11. A method for facilitating real-time comparison of outcome predictions for live micro-events within a live macro-event, the method comprising:
digitalizing video of the live micro-event into a plurality of first discrete digital components;
transmitting plurality of first discrete digital components to a game engine comprising a first non-transitory computer readable storage medium comprising first computer-executable instructions;
digitalizing user predictions of the outcome of a live macro-event and data feeds into a plurality of second discrete digital components;
transmitting the plurality of second discrete digital components to a backend server via at least one user communication device, the backend server having a second non-transitory computer readable storage medium comprising second computer-executable instructions;
transmitting the second discrete digital components to the game engine;
comparing, via the game engine, the second discrete digital components to the actual outcome of the live micro-event;
calculating user points from the comparison and points criteria stored in the first computer-executable instructions;
transmitting the user points to the backend server via the game engine; and
transmitting the user points to the user communication devices via the backend server.

12. A method of updating icons on a graphical user interface of a computer system, the method comprising:
displaying on a prediction input and outcome display section of the graphical user interface a plurality of input selection icons;
automatically generating input time-stamp limits via a processor that tracks historical user time to enter predictions, the input time-stamp limits automatically close a window of time for entry of the user predictions into the plurality of input selection icons;
calculating scores and results based on the processor analysis of a micro event;
automatically hiding the plurality of input selection icons based on the processor determining the status of the micro event;
displaying a plurality for results icons via the processor on the graphical user interface;
updating via the processor the plurality of input selection icons before a next micro event starts.

13. The method of claim 12, wherein the processor further updates the graphical user interface with a leader score icon.

14. The method of claim 12, wherein the processor further updates the graphical user interface with a statistics icon.
